(19) United States
(12) Patent Application Publication
(10) Pub. No.: US 2002/0187909 A1
(43) Pub. Date: Dec. 12, 2002

(54) Unit dose cleaning product

(75) Inventors: Neeraj Gupta, Wirral (GB); Ronald Hage, Vlaardingen (NL); Simon Marinus Veerman, Vlaardingen (NL)

Correspondence Address: UNILEVER, PATENT DEPARTMENT, 45 RIVER ROAD, EDGEWATER, NJ, 07020, US

(73) Assignee: Unilever Home & Personal Care USA, Division of Conopco, Inc.

(21) Appl. No.: 10/084,809

(22) Filed: Feb. 26, 2002

(30) Foreign Application Priority Data
Feb. 28, 2001 (GB) 0104979.0

(51) Int. Cl. C11D 17/00; C11D 9/42

(52) U.S. Cl. 510/295; 510/312; 510/375

(57) ABSTRACT

A unit dose cleaning product comprising a capsule formed of a material capable of dissolving, disintegrating or dispersing in a wash liquor, the capsule being filled with a substantially non-aqueous liquid cleaning composition in an amount sufficient to clean a single wash load, said composition including an organic substance with forms of a complex with a transition metal, the complex being capable of catalysing bleaching of a substrate by atmospheric oxygen.

### FIELD OF INVENTION

The present invention relates to unit dose liquid cleaning product containing substantially non-aqueous cleaning compositions.

### BACKGROUND OF INVENTION

Cleaning products are traditionally often liquids, viscous or thin, such as known for personal cleaning (bath and shower liquids and shampoos) or for domestic cleaning (hand dish wash and other hard surface cleaning, laundry-cleaning etc.) Other products are solids, such as powders, granules, small capsules (up to 2 mm diameter) or more recently tablets, for laundry and machine dish wash, and soap bars for skin cleaning. Recently, so called unit dose products are experiencing an increasing success with consumers, because they eliminate the need for manipulating, and possibly spilling, liquids or powders and simplify the use of a correct dose of the cleaning product for the required purpose. Examples thereof are the laundry and machine dish wash tablets mentioned above and recently described in F. Schambil and M. Böcker, Tenside Surf. Det. 37 (2000) 1.

Peroxygen bleaches are well known for their ability to remove stains from substrates. They are common ingredients in cleaning products, especially those for laundry cleaning. Traditionally, the substrate is subjected to hydrogen peroxide, or to substances which can generate hydroperoxyl radicals, such as inorganic or organic peroxides. Generally, these systems must be activated. One method of activation is to employ wash temperatures of 60° C. or higher. However, these high temperatures often lead to inefficient cleaning, and can also cause premature damage to the substrate.

A preferred approach to generating hydroperoxyl bleach species is the use of inorganic peroxides coupled with organic precursor compounds. These systems are employed for many commercial laundry powders. For example, various European systems are based on tetraacetyl ethylenediamine (TAED) as the organic precursor coupled with sodium perborate or sodium percarbonate, whereas in the United States laundry bleach products are typically based on sodium nonanoyloxybenzenesulphonate (SNOBS) as the organic precursor coupled with sodium perborate.

Our copending UK Patent Application No. 0009340.1, unpublished at the priority date of this application describes a unit dose water soluble package formed from a copolymeric polyvinyl alcohol film and containing a substantially non-aqueous liquid composition which comprises at least one ionic ingredient having an exchangeable hidrogen ion and a molar excess of a stabilising compound. However, there is no disclosure of such a composition having bleaching capabilities.

Another unit dose product contain a substantially non-aqueous liquid detergent in a rigid shell, also without bleaching capability is disclosed in our copending European Patent Application No 00201710.1, again, unpublished at the priority date of this application.

A problem with unit dose products incorporating substantially non-aqueous liquid detergents is that only a small liquid product volume is necessary to get effective cleaning. If one desires to incorporate a conventional peroxygen bleach in an effective bleaching amount, the internal volume of the product is really too small to accommodate it. The present invention overcomes this problem by incorporating a catalyst of bleaching by atmospheric oxygen.

The specification of WO 00/12677 discloses compositions and methods for catalytically bleaching substrates with atmospheric oxygen, using a metal-ligand complex as catalyst. These complexes allow catalytic bleaching by atmospheric oxygen without inclusion of peroxygen bleaches.

Our copending International Patent Application No. PCT/EP00/08076, unpublished at the priority date of this application, describes a liquid bleaching composition comprising an organic substance which forms a complex with a transition metal, the complex catalysing bleaching of a substrate by atmospheric oxygen, and a liquid carrier or solvent, wherein the composition is substantially devoid of peroxygen bleach or a peroxy-based or -generating bleach system. The composition is therefore preferably insensitive or stable to catalase, which acts on peroxy species. This is disclosed in various product forms such as aqueous and nonaqueous compositions in dilute or concentrated products or sheets, tapes or sticking plasters impregnated with the liquid or with the liquid contained with microcapsules. However, no unit dose product form is disclosed in which a package capable of dissolving, disintegrating or dissolving in the wash liquor contains a substantially nonaqueous liquid cleaning product.

### SUMMARY OF INVENTION

In a first aspect, the present invention provides a unit dose cleaning product comprising a capsule formed of a material capable of dissolving, disintegrating or dispersing in a wash liquor, the capsule being filled with a substantially non-aqueous liquid cleaning composition in an amount sufficient to clean a single wash load, said composition including an organic substance which forms a complex with a transition metal, the complex being capable of catalysing bleaching of a substrate by atmospheric oxygen.

In a second aspect, the present invention provides a method of cleaning a substrate comprising bringing into contact, a wash liquor in which is immersed, a unit dose product according to the first aspect of the present invention, and simultaneously or subsequently contacting the substrate with the wash liquor.

### DETAILED DESCRIPTION OF THE INVENTION

### The Capsule

The capsule may be of any form or substance capable of dissolving, disintegrating or dispersing in the wash liquor to deliver the contained unit dose of substantially non-aqueous liquid detergent composition. As used herein, the term “capsule” means any rigid or non rigid enclosure, whether seamless or made of two or more portions, of sheet or other material bonded or sealed to make the closed capsule containing the liquid ingredients. Optionally, it may comprise two or more compartments, e.g. to keep separate mutually incompatible components or components to be delivered at different times in the wash process.

For example, a unit-dose cleaning product may be a product of which a limited number of units provide the right amount of detergent to perform the cleaning operation for which the product is intended. This limited number will normally be between 1 and 10, preferably not more than 5 and typically between 1 and 3. Thus, for a floor cleaning product these 1-3 units in a bucket of water will usually provide a cleaning liquid of the desired strength, whereas for a hand dishwash product the equivalent would be 1-3 units in a dishwash bowl of water.

If the unit-dose cleaning product is water soluble, it is soluble to the extent that the dose (i.e. number of units) intended for a given amount of water should be able to give a clear solution and no solid particles visible to the naked eye should remain. A suitable dose unit should quickly dissolve 2000 times its weight of water, which amounts to a dilution of 2000 fold. Thus, all components in 10 g of unit dose product should be completely soluble in 20 l of water. More suitably the product, and therefore all the components in it, would also allow a dilution of only 1000 times, more preferably only 500 times even more preferably 200 times. Such solutions may be made in hot water, i.e. 100° C. or less, but preferably the product is also completely soluble in less hot water, i.e. at 70° C. or below, more preferably at 50° C. or even 30° C. Quick dissolution is defined as complete dissolution within 5 minutes with slight stirring, preferably within 2 minutes, more preferably within 1 minute.

The capsule may for example be formed of a water soluble film, such as of polyvinyl alcohol (PVA) or a copolymer containing same.

As used herein, the term “water soluble polymer” refers to a polymer which dissolves and/dispensers completely in water within 30 minutes with agitation, e.g. by means of hand, stick or other stirrer or under the action of a mechanical washing machine and at a relevant temperature. A “relevant temperature” is one at which the consumer will need to dissolve or disperse the polymer component at the beginning of, or during a cleaning process. A polymer is to be regarded as dissolving or dispersing at a “relevant temperature” if it does so under the aforementioned conditions at a temperature anywhere in the range of from 20° C. to 60° C.

Preferred water soluble polymers are those capable of being cast into a film or solid mass and may for example as described in Davidson and Sittig, Water-Soluble Resins, Van Nostrand Reinhold Company, New York (1968). The water-soluble polymer should have proper characteristics, such as strength and heat-sealability, to permit machine handling during the processes of making the water soluble package. Preferred water-soluble resins include polyvinyl alcohol, cellulose ethers, polyethylene oxide, starch, polyvinylpyrrolidone, polyacrylamide, polyvinyl methyl ether-maleic anhydride, polymaleic anhydride, styrene maleic anhydride, hydroxyethylcellulose, methylcellulose, polyethylene glycols, carboxymethylcellulose, polyacrylic acid salts, alginates, acrylamide copolymers, guar gum, casein, ethylene-maleic anhydride resin series, polyethyleneimine, ethyl hydroxyethylcellulose, ethyl methylcellulose, hydroxyethyl methylcellulose. Lower molecular weight water-soluble, polyvinyl alcohol film-forming resins are preferred.

Polyvinyl alcohols preferred for use therein have an average molecular weight anywhere between 1.000 and 100,000, preferably between 5,000 and 250,000, for example between 15,000 and 150,000. Hydrolysis, or alcoholysis, is defined as the percent completion of the reaction where acetate groups on the resin are substituted with hydroxyl, —OH, groups, A hydrolysis range of from 60-99% of polyvinyl alcohol film-forming resin is preferred, while a more preferred range of hydrolysis is from about 70-90% for water-soluble, polyvinyl alcohol film-forming resins. The most preferred range of hydrolysis is 80-89%. As used in this application, the term “polyvinyl alcohol” includes polyvinyl acetate compounds with levels of hydroloysis disclosed herein. The water-soluble resin film should be formulated so as to substantially completely dissolve in 50° C. water with agitation within about thirty minutes, preferably within about 15 minutes in 50° C. water with agitation, and most preferably within about 5 minutes in 50° C. water with agitation.

An especially preferred plastics film is a polyvinyl alcohol film, made of a polyvinyl alcohol copolymer having a comonomer having a carboxylate function.

PVA can be made by the polymerisation of vinyl acetate, followed by hydrolysis, conveniently by reaction with sodium hydroxide. However, the resulting film has a highly symmetrical, hydrogen-bonded structure and is not readily soluble in cold water. PVOH films which are suitable for the formation of water soluble packages are typically polymers produced from copolymerisation of vinyl acetate and another comonomer which contains a carboxylic function. Examples of such comonomers include monocarboxylates, such as acrylic acid, and dicarboxylates, such as itaconic acid, which may be present during polymerisation as esters. Alternatively, the anhydride of maleic acid may be used as the copolymer. The inclusion of the comonomer reduces the symmetry of and degree of hydrogen bonding in the final film and renders the film soluble even in cold water.

Suitable PVA films for use in a package according to the invention are commercially available and described, for example, in EP-B-0 291 198. PVA films for use in a package according to the invention can be made by the copolymerisation of vinyl acetate and a carboxylate-containing monomer (for example acrylic, maleic or itaconic acid or acid ester), followed by partial (for example up to about 90%) hydrolysis with sodium hydroxide.

The film may incorporate a plasticiser.

As will be elucidated in more detail hereinbelow, the water soluble film may be formed from a variety of different materials. The plasticiser will depend on the nature of the film in question. Preferred plasticisers are recited in more detail in the section of this description dealing with these film materials. One or more plasticisers may independently be incorporated in the film and in the liquid composition. However, it is very much preferred for the identity of the plasticiser(s) in the film and in the liquid composition to be substantially the same.

The plasticiser system influences the way the polymer chains react to external factors such as compression and extensional forces, temperature and mechanical shock by controlling the way that the chains distort/realign as a consequences of these intrusions and their propensity to revert or recover to their former state. The key feature of preferred plasticisers is that they are highly compatible with the film, and are normally hydrophilic in nature.

Generally speaking, plasticisers suitable for use with PVA-based films have —OH groups in common with the ˜CH2—CH(OH)—CH2—CH(OH)-polymer chain of the film polymer.

Their mode of functionality is to introduce short chain hydrogen bonding with the chain hydroxyl groups and thus weaken adjacent chain interactions which inhibits swelling of the aggregate polymer mass—the first stage of film dissolution.

Water itself is a suitable plasticiser for any of the films recited herein but other common plasticisers include:

Polyhydroxy compounds, e.g. glycerol, trimethylolpropane, diethylene glycol, triethylene glycol, dipropylene glycol

Starches e.g. starch ether, esterificated starch, oxidized starch and starches from potato, tapioca and wheat

Cellulosics/carbohydrates, e.g. amylopectin, dextrin carboxymethylcelluose and pectin. The amount of plasticiser per unit weight of film may vary considerably according to the film type and plasticiser type(s). It could, for example be in the range of from 0.1% to 50%, e.g. 10% to 45%, such as 20% to 40% by weight.

Polyvinylpyrrolidone is (PVP), another preferred polymer for use in the articles of the present invention. Dried, unmodified films of PVP are clear or transparent, glossy and reasonably hard. Modifiers may be used in concentrations of 10 to 50% to control tack, brittleness or to decrease the hygroscopicity. Unmodified PVP films are relatively very hygroscopic in character, and moisture taken up from the air can also act as plasticiser. Other plasticisers are for example glycerol, propylene glycol, diethylene glycol and sorbitol. These tend to increase tackiness of the PVP film. Carboxymethylcellulose or cellulose acetate can be used to decrease tackiness. Films essentially tack-free over all ranges of relative humidity may be also obtained by incorporation of 10% arylsulfonamide-formaldehyde resin.

Preferred water-soluble films may also be prepared from polyethylene oxide (PEO). High molecular weight polymers of ethylene oxide with molecular weight of about 100,000 to 5,000,000 form strong, translucent, thermoplastic films. Unfunctionalised films of these resins easily crack when only minor stress is applied (a process known as ‘stress cracking’). This is accelerated by exposure to ultraviolet radiation but can be slowed down or inhibited completely by the addition of plasticisers in combination with suitable UV radiation inhibitors. Suitable plasticisers are for example (low molecular weight) polyethylene glycol and polypropylene glycol, carbohydrates, glycerol, organic and inorganic esters such as glycerol triacetate or triethyl citrate.

PEO films generally have very good mechanical properties and heat sealability, combined with complete water solubility. In comparison with other commonly used water-soluble films, polyethylene oxide films offer the advantage of good compatibility.

Further examples of suitable water soluble polymers are modified celluloses, such as methylcellulose (MC) and hydroxypropylmethylcellulose (HPMC). These yield high-strength, clear, water-soluble films that are impervious to many organic and petroleum-based solvents. The mechanical properties can be modified by a number of plasticisers, such as glycerol, propylene glycol, sorbitol, diethylene glycol, triethanol amine, and N-acetyl ethanol amine. Properly plasticised MC or HPMC sheeting products can be sealed at about 130° C. using standard sealing equipment.

An alternative cellulose-based material is hydroxypropyl cellulose (HPC). Clear, flexible films of this material may be prepared from aqueous or organic solvent solutions of the polymer. An advantage of HPC is that it has good plastic-flow properties enabling it to be thermoformed into flexible film articles without the aid of plasticisers or other additives. They are non-tacky even at high humidity. The unplasticised film has good cold water solubility but is insoluble in water >45° C.

All of the above polymers include the aforementioned polymer classes whether as single polymers or as copolymers formed of monomer units or as copolymers formed of monomer units derived from the specified class or as copolymers wherein those monomer units are copolymerised with one or more comonomer units.

Blends (i.e. not copolymers) of two or more polymers recited herein, may also be used.

### Encapsulation Methods

(a) Horizontal Form-fill-seal

Water soluble based on PVA can be made according to any of the methods horizontal form-fill-seal described in any of WO-A-00/55044, WO-A-00/55045, WO-A-00/55046, WO-A-00/55068, WO-A-00/55069 and WO-A-00/55415.

By way of example, a thermoforming process is now described where a number of packages according to the invention are produced from two sheets of water soluble material. In this regard recesses are formed in the film sheet using a forming die having a plurality of cavities with dimensions corresponding generally to the dimensions of the packages to be produced. Further, a single heating plate is used for thermoforming the film for all the cavities, and in the same way a single sealing plate is described.

A first sheet of polyvinyl alcohol film is drawn over a forming die so that the film is placed over the plurality of forming cavities in the die. In this example each cavity is generally dome shape having a round edge, the edges of the cavities further being rounded to remove any sharp edges which might damage the film during the forming or sealing steps of the process. Each cavity further includes a raised surrounding flange. In order to maximise package strength; the film is delivered to the forming die in a crease free form and with minimum tension. In the forming step, the film is heated to 100 to 120° C., preferably approximately 110° C., for up to 5 seconds, preferably approximately 700 micro seconds. A heating plate is used to heat the film, which plate is positioned to superpose the forming die. During this preheating step, a vacuum of 0.5 bar is pulled through the pre-heating plate to ensure intimate contact between the film and the pre-heating plate, this intimate contact ensuring that the film is heated evenly and uniformly (the extent of the vacuum is dependant of the thermoforming conditions and the type of film used, however in the present context a vacuum of less than 0.6 bar was found to be suitable). Non-uniform heating results in a formed package having weak spots. In addition to the vacuum, it is possible to blow air against the film to force it into intimate contact with the preheating plate.

The thermoformed film is moulded into the cavities blowing the film off the heating plate and/or by sucking the film into the cavities thus forming a plurality of recesses in the film which, once formed, are retained in their thermoformed orientation by the application of a vacuum through the walls of the cavities. This vacuum is maintained at least until the packages are sealed. Once the recesses are formed and held in position by the vacuum, a liquid composition according to the invention is added to each of the recesses. A second sheet of polyvinyl alcohol film is then superposed on the first sheet across the filled recesses and heat-sealed thereto using a sealing plate. In this case the heat sealing plate, which is generally flat, operates at a temperature of about 140 to 160° C., and contacts the films for 1 to 2 seconds and with a force of 8 to 30 kg/cm², preferably 10 to 20 kg/cm². The raised flanges surrounding each cavity ensure that the films are sealed together along the flange to form a continuous seal. The rounded edge of each cavity is at least partly formed by a resiliently deformable material, such as for example silicone rubber. This results in reduced force being applied at the inner edge of the sealing flange to avoid heat/pressure damage to the film.

Once sealed, the packages formed are separated from the web of sheet film using cutting means. At this stage it is possible to release the vacuum on the die, and eject the formed packages from the forming die. In this way the packages are formed, filled and sealed while nesting in the forming die. In addition they may be cut while in the forming die as well.

During the forming, filling and sealing steps of the process, the relative humidity of the atmosphere is controlled to ca. 50% humidity. This is done to maintain the heat sealing characteristics of the film. When handling thinner films, it may be necessary to reduce the relative humidity to ensure that the films have a relatively low degree of plasticisation and are therefore stiffer and easier to handle.

(b) Vertical Form-Fill-Seal

In the vertical form-fill-seal (VFFS) technique, a continuous tube of flexible plastics film is extruded. It is sealed, preferably by heat or ultrasonic sealing, at the bottom, filled with the liquid composition, sealed again above the liquid film and then removed from the continuous tube, e.g. by cutting.

Encapsulation methods for other water soluble films such as based on PVP or PEO will be known to those skilled in the art.

### Unit Dose Volume

The amount of the substantially non-aqueous liquid cleaning composition is each unit dose envelope may for example be from 10 ml to 100 ml, e.g. from 12.5 ml to 75 ml, preferably from 15 ml to 60 ml, more preferably from 20 ml to 55 ml.

Any reference herein to filling refers to complete filling and also partial filling whereby some air or other gas is also trapped in the sealed envelope.

### The Substantially Non-Aqueous Liquid Cleaning Composition

### Non-Aqueous Liquid Component

The substantially non-aqueous liquid cleaning composition must contain at least one non-aqueous liquid. Further, the non-aqueous liquid itself and/or another component of the composition must provide a cleaning function when released into the wash liquor.

By “substantially non-aqueous” it is meant that that the amount of water in the liquid composition is below the level at which the package would dissolve through contact with its contents. Preferably, the liquid composition comprises 25%, e.g. no more than 20%, more preferably no more than about 15%, still more preferably no more from 10%, such as no more than about 7%, even more preferably no more than about 5% and most preferably no more than from about 3% to about 4%, by weight water. However, in some cases, it may be possible (whether by reason of the thickness of the film used, the physical properties, such as viscosity, of the liquid composition or otherwise) to use even higher quantities of water in the liquid composition inside the package according to the invention, although these should never exceed 50% by weight of the liquid composition.

The substantially non-aqueous liquid composition may be substantially Newtonion or else non-Newtonion in rheology. The latter especially applies when the composition comprises dispersed solids. Therefore, for the avoidance of doubt, all viscosities expressed herein are measured at a shear rate of 21s⁻¹.

The viscosity of the composition is preferably from 25 mPaS, 50 mPaS, 75 mPaS or 100 mPaS, preferably 125 mPaS, more preferably 150 mPaS to 10,000 mPaS, for example above 150 mPaS but no more than 10,000 mPaS. The alternative embodiment of the invention relates to VFFS encapsulation in which case, the minimum viscosity must be 10 mPaS, for example above 150 mPaS.

The composition may be considered as falling into the sub-classes of thin liquids, thick liquids, and gels/pastes.

The thin liquids may have a minimum viscosity of 25, 50, 75, 100, 125 ,150 mPaS or above 150 mPaS for example 175 mPaS, preferably 200 mPaS. They may for example have a maximum viscosity of 500 mPaS preferably 450 mPaS more preferably 400 mPaS or even 250 mPaS.

The thick liquids may have a minimum viscosity of 400 mPaS, for example 350 mPaS, or even 300 mPaS and a maximum viscosity of 1,500 mPaS, preferably 1,200 mPaS.

The gels or pastes may have a minimum viscosity of 1,400 mPaS, for example 1,500 mPaS, preferably 1,750 mPaS, 2000 mPaS, 2,500 mPaS, 3,000 mPaS or even 3,500 mPaS. Their maximum viscosity may be 10,000 mPaS, preferably 9,000 mPaS, more preferably 8,000 mPaS, 7,500 mPaS or even 4,000 mPaS.

The non-aqueous liquid may comprise one or more non-aqueous liquid components. These may be one or more liquid surfactants and/or one or more non-aqueous non-surfactant liquids.

Suitable liquid surfactants are liquid nonionic surfactants.

Nonionic detergent surfactants are well-known in the art. They normally consist of a water-solubilizing polyalkoxylene or a mono- or di-alkanolamide group in chemical combination with an organic hydrophobic group derived, for example, from alkylphenols in which the alkyl group contains from about 6 to about 12 carbon atoms, dialkylphenols in which primary, secondary or tertiary aliphatic alcohols (or alkyl-capped derivatives thereof, preferably having from 8 to 20 carbon atoms, monocarboxylic acids having from 10 to about 24 carbon atoms in the alkyl group and polyoxypropylense. Also common are fatty acid mono- and dialkanolamides in which the alkyl group of the fatty acid radical contains from 10 to about 20 carbon atoms and the alkyloyl group having from 1 to 3 carbon atoms. In any of the mono- and di-alkanolamide derivatives, optionally, there may be a polyoxyalkylene moiety joining the latter groups and the hydrophobic part of the molecule. In all polyalkoxylene containing surfactants, the polyalkoxylene moiety preferably consists of from 2 to 20 groups of ethylene oxide or of ethylene oxide and propylene oxide groups. Amongst the latter class, particularly preferred are those described in the applicants' published European specification EP-A-225,654, especially for use as all or part of the solvent. Also preferred are those ethoxylated nonionics which are the condensation products of fatty alcohols with from 9 to 15 carbon atoms condensed with from 3 to 11 moles of ethylene oxide. Examples of these are the condensation products of C₁₁₋₁₃ alcohols with (say) 3 or 7 moles of ethylene oxide. These may be used as the sole nonionic surfactants or in combination with those of the described in the last-mentioned European specification, especially as all or part of the solvent.

Another class of suitable nonionics comprise the alkyl polysaccharides (polyglycosides/oligosaccharides) such as described in any of specifications U.S. Pat. Nos. 3,640,998; 3,346,558; 4,223,129; EP-A-92,355; EP-A-99,183; EP 70,074, '75, '76, '77; EP 75,994, '95, '96.

Nonionic detergent surfactants normally have molecular weights of from about 300 to about 11,000. Mixtures of different nonionic detergent surfactants may also be used, provided the mixture is liquid at room temperature.

Suitable non-aqueous non-surfactant liquids forms can be used alone or with in combination with liquid surfactants. Non-surfactant solvents which are more preferred category include ethers, polyethers, alkylamines and fatty amines, (especially di- and tri-alkyl- and/or fatty-N-substituted amines), alkyl (or fatty) amides and mono- and di- N-alkyl substituted derivatives thereof, alkyl (or fatty) carboxylic acid lower alkyl esters, ketones, aldehydes, polyols, and glycerides. Specific examples include respectively, di-alkyl ethers, polyethylene glycols, alkyl ketones (such as acetone) and glyceryl trialkylcarboxylates (such as glyceryl tri-acetate), glycerol, propylene glycol, and sorbitol.

Other suitable solvents are lower (C₁₋₄) alcohols, such as ethanol, or higher (C₅₋₉) alcohols, such as hexanol, as well as alkanes and olefins. However, they can be combined with other solvent materials which are surfactants and non-surfactants having the aforementioned “preferred” kinds of molecular structure. Even though they appear not to play a role in the deflocculation process of dispersed solids, it is often desirable to include them for lowering the viscosity of the product and/or assisting soil removal during cleaning.

Preferably, the compositions of the invention contain the organic solvent (whether or not comprising liquid surfactant) in an amount of at least 10% by weight of the total composition. The amount of the solvent present in the composition may be as high as about 90%, but in most cases the practical amount will lie between 20 and 70% and sometimes, between 20 and 50% by weight of the composition. The weight ratio of surfactant to non-surfactant non-aqueous liquid components is preferably from 0:10 to 10:0, more preferably from 1:10 to 10:1, still more preferably from 1:6 to 6:1, yet more preferably from 1:5 to 5:1, e.g. from 1:3 to 3:1.

Whether or not the composition contains nonionic surfactant, as well as the material of formula (I), one or more other surfactants may be present. These may be in liquid form or as solid dissolved or dispersed in the substantially non-aqueous liquid component. They may be selected from anionic cationic and ampholytic detergent surfactants. The anionic surfactants may be incorporated in free acid and/or neutralised form. The cationic surfactant may be neutralised with a counter ion or it may be used as stabilising compound to neutralise the at least one ionic ingredient with an exchangeable hydrogen ion.

The composition may also comprise one or more solid dissolved and/or dispersed in the substantially non-aqueous liquid. When these are dispersed solids, it is preferred also to include one or more deflocculating agents as described in EP-A-0 266 199.

Some of these ingredients may be of an acidic nature, such as soaps or the acid precursors of anionic surfactants (which can be used for their surfactant properties and/or as deflocculants). These materials have an exchangeable hydrogen ion. As already mentioned, according to our copending but unpublished application PCT/EP01/03770, when the liquid composition comprises at least one “acidic” component having an exchangeable hydrogen ion, and the film is a PVA film including carboxyl-functional co-monomers, it is preferred to substantially neutralise or over-neutralise this component with a stabilising compound. This is to solve the following problem.

PVOH can be made by the polymerisation of vinyl acetate, followed by hydrolysis, conveniently by reaction with sodium hydroxide. However, the resulting film has a highly symmetrical, hydrogen-bonded structure and is not readily soluble in cold water. PVOH films which are suitable for the formation of water soluble packages are typically polymers produced from copolymerisation of vinyl acetate and another comonomer which contains a carboxylic function. Examples of such comonomers include monocarboxylates, such as acrylic acid, and dicarboxylates, such as itaconic acid, which may be present during polymerisation as esters. Alternatively, the anhydride of maleic acid may be used as the copolymer. The inclusion of the comonomer reduces the symmetry of and degree of hydrogen bonding in the final film and renders the film soluble even in cold water.

However, when the resultant copolymer film contains carboxylic acid or carboxylate groups (either of these hereinafter being referred to as “carboxylate functionality”) in proximity to hydroxyl groups on the same carbon chain and there is an attendant drive towards cyclisation of these groups by water elimination to form lactones. A low level of lactone formation is desirable to improve the mechanical properties of the film. However, the formation of excessive amounts of lactones is undesirable as this tends to reduce the cold water solubility of the film, giving rise to a danger of undissolved film residues when the package is used.

The problem of excessive lactone formation is particularly acute when the liquid composition inside the package comprises ionic species. This is thought to be because the presence of ionic species can give rise to exchange between sodium ions (associated with carboxylate groups) in the film and hydrogen ions in the liquid composition. Once such exchange has occurred, the resulting carboxylic acid group in the film can cyclise with a neighbouring hydroxyl group, eliminating water in the process, thus forming lactones.

### Ionic Ingredients with Exchangeable Hydrogen Ions

Ionic ingredient(s) with exchangeable hydrogen ions may, for example, constitute from between 1% and 40% (prior to any neutralisation) by weight of the total substantially non-aqueous liquid composition. If incorporated in unneutralised form (M=H), the material(s) of formula (I) constitute one material with exchangeable hydrogen ions. When used primarily for their surfactant properties, such ingredients may for example be present in amounts greater than 10% by weight. When used as deflocculants (see below), the amounts may be 10% by weight or less, e.g. no more than 5% by weight. These ingredients may for example be selected from anionic surfactant acid precursors and fatty acids and mixtures thereof.

Other anionic surfactant acids are well known to those skilled in the art. Examples suitable for use in a liquid composition according to the invention include alkylbenzene sulphonic acid, particularly C₈₋₁₅ linear alkylbenzene sulphonic acids and mixtures thereof. Other suitable surfactant acids include the acid forms of olefin sulphonates, alkyl ether sulphates, alkyl sulphates or alkane sulphonates and mixtures thereof.

A wide range of fatty acids are suitable for inclusion in a liquid composition according to the invention, for example selected from one or more C₈₋₂₄ alkyl or alkenyl monocarboxylic acids. Saturated or unsaturated fatty acids may be used. Examples of suitable fatty acids include oleic acid, lauric acid or hardened tallow fatty acid.

### Stablilising Compound

The provision of a molar excess (with respect to the amount of exchangeable hydrogen ions in the at least one ionic ingredient) of the stabilising compound in the liquid composition is found to have a significant effect in maintaining the cold water solubility of the film through the hindrance of lactone formation. However, in the case of inorganic bases and/or ammonium hydroxide forming all or part of the stabilising compound, the amount of stabilising compound need not be in excess, provided it is at least 95 mole % of the amount needed for full neutralisation. Surprisingly, the hindrance of lactone formation is significantly greater when these amounts of stabilising compound is used than when a molar equivalent or less is used. This advantageous effect is particularly marked after prolonged storage (eg for several weeks) of the package according to the invention at elevated temperature (eg 37° C.), conditions which are frequently encountered by some commercial products in European and other markets.

The problem of excessive lactone formation is particularly acute when the liquid composition inside the package comprises ionic species having an exchangeable hydrogen ion, for example fatty acids or the acid precursors of anionic surfactants.

This problem may be solved by including in the composition, a stabilising compound effective for combining with the exchangeable hydrogen ions to hinder the formation of lactones within the film. This stabilising compound should preferably be in molar excess relative to the component(s) having an exchangeable ion. This molar excess is preferably up to 105 mole %, preferably up to 110 mole % of the stoichiometric amount necessary for complete neutralisation. It is preferably an organic base such as one or more amines, e.g. monoethanolamine, triethanolamine and mixtures thereof. When the stabilising compound is or comprises an inorganic base such as an alkali metal (e.g. sodium or potassium) hydroxide, or ammonium hydroxide, it may, however, present in an amount as low as 95 mole %, eg. from 95 mole % to 105 mole % relative to the component(s) having an exchangeable hydrogen ion.

In other aspects of the invention, for the stabilising compound, instead of the 95 mole %, we may claim as minimum, any of 90, 91, 92, 93, 94, 94.4, 96, 96.5, 97, 97.5, 98, 98.5, 99 and 99.5 mole %. Also, independently of any particular minimum, in other aspects of the invention, as maximum, we may claim any of 100.25, 100.5, 101, 101.5, 102, 102.5, 103, 103.5, 104, 105, 106, 107, 108, 109 and 110 mole %.

Other possible inorganic stabilising compounds are alkaline earth metal hydroxides or other inorganic bases which do liberate water on protonation. These are preferably also used in an amount indicated above for the alkali metal hydroxides and ammonium hydroxide.

Yet other suitable stabilising compounds are amines other than monoethanolamine and triethanolamine, and organic Lewis bases or other organic or inorganic bases provided that they will interact effectively with labile protons within the detergent composition to hinder the production of lactones in the film.

### Optional Bleach

Whilst the present invention is based on the catalytic bleaching of a substrate by atmospheric oxygen or air, it will be appreciated that small amounts of hydrogen peroxide or peroxy-based or -generating systems may be included in the liquid composition, if desired, provided that the chemical and physical stability of the composition is not thereby adversely affected to an unacceptable level. Therefore, the liquid bleaching composition preferably contains from 0 to 50%, more preferably from 0 to 10%, still more preferably from 0 to 5%, and optimally from 0 to 2% by molar weight on an oxygen basis, of peroxygen bleach or peroxy-based or -generating bleach systems. Preferably, however, the liquid bleaching composition will be wholly devoid of peroxygen bleach or peroxy-based or -generating bleach systems.

Thus, at least 10%, preferably at least 50% and optimally at least 90% of any bleaching of the substrate is effected by oxygen sourced from the air.

Suitable option oxygen bleaches are, for example in the form of an inorganic persalt preferably with an activator, or as a peroxy acid compound.

In the case of the inorganic persalt bleaches, the activator makes the bleaching more effective at lower temperatures, i.e. in the range from ambient temperature to about 60° C., so that such bleach systems are commonly known as low-temperature bleach systems and are well known in the art. The inorganic persalt such as sodium perborate, both the monohydrate and the tetrahydrate, acts as release active oxygen n solution, and activator is usually an organic compound havine one or more reactive acyl residues, which cause the formation of peracids, the latter providing for more effective bleaching action at lower temperatures than the peroxy-bleach compound alone. The ratio by weight of the peroxy bleach compound to the activator is from about 15:1 to about 2:1, preferably from about 10:1 to about 3.5:1. Whilst the amount of the bleach system, i.e. peroxy bleach compounds and activator may be varied between about 5% and about 35% by weight of the total liquid, it is preferred to use from about 6% to about 30% of the ingredients forming the bleach system. Thus, the preferred level of the peroxy bleach compound in the composition is between 5.5% and about 27% by weight, while the preferred level of the activator is between about 0.5% and about 40%, most preferably between about 1% and about 5% by weight.

Typical examples of the suitable peroxybleach compounds are alkalimetal perborates, both tetrahdyrates and monohydrates, alkali metal, percarbonates, alkylhydroperoxides such as cumene hydroperoxide and t-butyl hydroperoxide, persilicates and perphosphates, of which sodium perborate is preferred. Activators for peroxybleach compounds have been amply described in the literature, including in British patent specifications 836988, 855735,907356, 907358, 907950, 1003310 and 1246339, U.S. Pat. Nos. 3,332,882 and 4,128,494, Canadian patent specification 844481 and South African patent specification 68/6344.

The exact mode of action of such activators is not known, but it is believed that peracids are formed by reaction of the activators with the inorganic peroxy compound, which peracids then liberate active-oxygen by decomposition.

They are generally compounds which contain N-acyl or O-acyl residues in the molecule and which exert their activating action on the peroxy compounds on contact with these in the washing liquor.

Typical examples of activators within these groups are polyacylated alkylene diamines, such N,N,N¹N,¹⁻tetraacetylethylene diamine (TAED) and N,N,N¹,N¹⁻tetraacetylmethylene diamine (TAMD); acylated glycolurils, such as tetraacetylgylcoluril (TAGU); triacetylcyanurate and sodium sulphophenyl ethyl carbonic acid ester.

A particularly preferred activator is N,N,N¹N¹⁻tetraacetylethylene diamine (TAED). The activator may be incorporated as fine particles or even in granular form, such as described in the applicants' UK patent specification GB 2 053 998 A. Specifically, it is preferred to have an activator of an average particle size of less than 150 micrometers, which gives significant improvement in bleach efficiency. The sedimentation losses, when using an activator with an average particle size of less than 150 μm, are substantially decreased. Even better bleach performance is obtained if the average particle size of the activator is less than 100 μm. However, too small a particle size can give increased decomposition and handling problems prior to processing. However, these particle sizes have to be reconciled with the requirements for dispersion in the solvent (it will be recalled that the aforementioned first product from requires particles which are as small as possible within practical limits). Liquid activators may also be used, e.g. as hereinafter described.

The organic peroxyacid compound bleaches (which in some cases can also act as structurants/deflocculants) are preferably those which are solid at room temperature and most preferably should have a melting point of at least 50° C. Most commonly, they are the organic peroxyacids and water-soluble salts thereof having the general formula

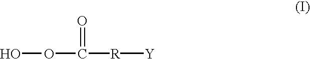

wherein R is an alkylene or substituted alkylene group containing 1 to 20 carbon atoms or an arylene group containing from 6 to 8 carbon atoms, and Y is hydrogen halogen, alkyl, aryl or any group which provides an anionic moiety in aqueous solution. Such Y groups can include, for example:

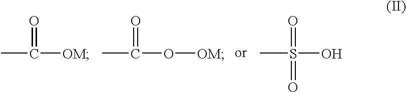

wherein M is H or a water-soluble, salt-forming cation.

The organic peroxyacids and salts thereof usable in the present invention can contain either one, two or more peroxy groups and can be either aliphatic or aromatic. When the organic peroxyacid is aliphitic, the unsubstituted acid may have the general formula:

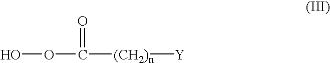

wherein Y can be H, —CH₃, —CH₂Cl,

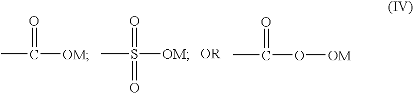

And n can be an integer from 60 to 20. Peroxydodecanoic acids, peroxytetradecanoic acids and peroxyhexadecanoic acids are the most preferred compounds of this type, particularly 1,12-diperoxydodecandioic acid (sometimes known as DPDA), 1,14-diperoxytetradecandioic acid and 1,16diperoxyhexadecandioic acid. Examples of other preferred compounds of this type are diperoxyazelaic acid, diperoxyadipic and diperoxysebacic acid.

When the organic peroxyacid is aromatic, a unsubstituted acid may have the general formula:

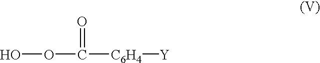

wherein Y is, for example hydrogen, halogen, alkyl or a group as defined for formulae (IV) above.

The percarboxy and Y groupings can be in any relative position around the aromatic ring. The ring and/or Y group (if alkyl) can contain any non-interfering substitutents such as halogen or sulphonate groups. Examples of suitable aromatic peroxyacids and saltes thereof include monoperoxyphthalic acid, diperoxyterephthalic acid, 4-chlorodiperoxy-phthalic acid, diperoxyisophthalic acid, peroxy benzoic acids and ring-substituted peroxy benzoic acids, such as peroxy-alpha-naphthoic acid. A preferred aromatic peroxyacid is diperoxyisophthalic acid.

Another preferred class of peroxygen compounds which can be incorporated to enhance dispensing/dispersibility in water are the anyhdrous perborates described for that purpose in the applicants' European patent specification EP-A-217 454.

Transition metal sequestrants such as EDTA, and phosphonic acid derivatives such as EDTMP (ethylene diamine tetra(methylene phosphonate)) may also be included, in addition to the organic substance specified, for example to improve the stability sensitive ingredients such as enzymes, fluorescent agents and perfumes, but provided the composition remains bleaching effective. However, the liquid composition containing the organic substance, is preferably substantially, and more preferably completely, devoid of transition metal sequestrants (other than the organic substance).

### The Organic Substance

The present invention requires the presence of an organic substance which forms a complex with a transition metal capable of catalysing atmospheric oxygen bleaches.

The organic substance may be incorporated in compsitions according to the invention, either as a preformed complex of an organic ligand and a transition metal. Alternatively, it may be incorporated as the free organic substance. Without being bound by any theory, it is supposed that the organic substance can complex with a transition metal already present in the water or it might complex with a transition metal present in the substrate. The free organic substance may also be included as a composition of the free organic or a transition metal-substitutable metal-ligand complex, and a source of transition metal, whereby the complex is formed in situ in the medium. Generally speaking, the organic substance will usually be an organic ligand. It is preferred that the ligand is a pentadentate ligand or complex thereof.

The ligand forms a complex with one or more transition metals, in the latter case for example as a dinuclear complex. Suitable transition metals include for example: manganese in oxidation states II-V, iron II-V, copper I-III, cobalt I-III, titanium II-IV, tungsten IV-VI, vanadium II-V and molybdenum II-VI.

The transition metal complex preferably is of the general formula:

[MₐLₖXₙ]Yₘ (Al)

in which:

M represents a metal selected from Mn(II)-(II)-(IV)-(V), Cu(I)-(II)-(III), Fe (II)-(III)-(IV)-(V), Co(I)-(II)-(III), Ti(II)-(III)-(IV), V(II)-(III)-(IV)-(V), Mo(II)-(III)-(IV)-(V)-(VI) and W(IV)-(V)-(VI), preferably from Fe(II)-(III)-(IV)-(V);

L represents the ligand, preferably N,N-bis(pyridin-2-yl-methyl)-1,1-bis(pyridin-2-yl)-1-aminoethane, or its protonated or deprotonated analogue;

X represents a coordinating species selected from any mono, bi or tri charged anions and any neutral molecules able to coordinate the metal in a mono, bi or tridentate manner;

Y represents any non-coordinated counter ion;

a represents an integer from 1 to 10;

k represents an integer from 1 to 10:

n represents zero or an integer from 1 to 10;

m represents zero or an integer from 1 to 20.

It is preferred that the organic molecule (ligand) or transition metal complex is present in the composition such that a unit dose provides at least 0.1 μM of the organic molecule or transition metal complex thereof.

Preferably, the complex is an iron complex comprising the ligand N,N-bis(pyridin-2-yl-methyl)-1,1-bis(pyridin-2-yl)-1-aminoethane. However, it will be appreciated that the pretreatment method of the present invention may instead, or additionally, use other ligands and transition metal complexes, provided that the complex formed is capable of catalysing stain bleaching by atmospheric oxygen. Suitable classes of ligands are described below:

(A) Ligands of the general formula (IA):

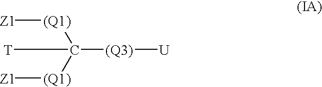

wherein

Z1 groups independently represent a coordinating group selected from hydroxy, amino, —NHR or —N(R)₂ (wherein R=C₁₋₆-alkyl), carboxylate, amido, —NH—C(NH)NH₂, hydroxyphenyl, a heterocyclic ring optionally substituted by one or more functional groups E or a heteroaromatic ring optionally substituted by one or more functional groups E, the heteroaromatic ring being selected from pyridine, pyrimidine, pyrazine, pyrazole, imidazole, benzimidazole, quinoline, quinoxaline, triazole, isoquinoline, carbazole, indole, isoindole, oxazole and thiazole;

Q1 and Q3 independently represent a group of the formula:

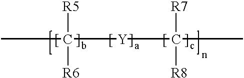

wherein

5≧a+b+c≧1; a=0-5; b=0-5; c=0-5; n=0 or 1 (preferably n=0);

Y independently represents a group selected from —O—, —S—, —SO—, SO₂—, —C(O)—, arylene, alkylene, heteroarylene, heterocycloalkylene, —(G)P—, —P(O)— and —(G)N—, wherein G is selected from hydrogen, alkyl, aryl, arylalkyl, cycloalkyl, each except hydrogen being optionally substituted by one or more functional groups E;

R5, R6, R7, R8 independently represent a group selected from hydrogen, hydroxyl, halogen, —R and —OR, wherein R represents alkyl, alkenyl, cycloalkyl, heterocycloalkyl, aryl, heteroaryl or a carbonyl derivative group, R being optionally substituted by one or more functional groups E,

or R5 together with R6, or R7 together with R8, or both, represent oxygen,

or R5 together with R7 and/or independently R6 together with R8, or R5 together with R8 and/or independently R6 together with R7, represent C₁₋₆-alkylene optionally substituted by C₁₋₄-alkyl, —F, —Cl, —Br or —I;

T represents a non-coordinated group selected from hydrogen, hydroxyl, halogen, —R and —OR, wherein R represents alkyl, alkenyl, cycloalkyl, heterocycloalkyl, aryl, arylalkyl, heteroaryl or a carbonyl derivative group, R being optionally substituted by one or more functional groups E (preferably T=—H, —OH, methyl, methoxy or benzyl);

U represents either a non-coordinated group T independently defined as above or a coordinating group of the general formula (IIA), (IIIA) or (IVA):

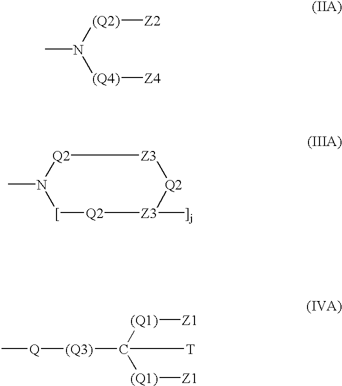

wherein

Q2 and Q4 are independently defined as for Q1 and Q3;

Q represents —N(T)— (wherein T is independently defined as above), or an optionally substituted heterocyclic ring or an optionally substituted heteroaromatic ring selected from pyridine, pyrimidine, pyrazine, pyrazole, imidazole, benzimidazole, quinoline, quinoxaline, triazole, isoquinoline, carbazole, indole, isoindole, oxazole and thiazole;

Z2 is independently defined as for Z1;

Z3 groups independently represent —N(T)- (wherein T is independently defined as above);

Z4 represents a coordinating or non-coordinating group selected from hydrogen, hydroxyl, halogen, —NH—C(NH)NH₂, —R and —OR, wherein R=alkyl, alkenyl, cycloalkyl, heterocycloalkyl, aryl, heteroaryl or a carbonyl derivative group, R being optionally substituted by one or more functional groups E, or Z4 represents a group of the general formula (IIAa):

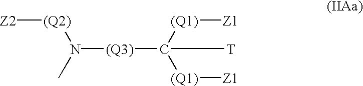

and

1≦j<4.

Preferably, Z1, Z2 and Z4 independently represent an optionally substituted heterocyclic ring or an optionally substituted heteroaromatic ring selected from pyridine, pyrimidine, pyrazine, pyrazole, imidazole, benzimidazole, quinoline, quinoxaline, triazole, isoquinoline, carbazole, indole, isoindole, oxazole and thiazole. More preferably, Z1, Z2 and Z4 independently represent groups selected from optionally substituted pyridin-2-yl, optionally substituted imidazol-2-yl, optionally substituted imidazol-4-yl, optionally substituted pyrazol-1-yl, and optionally substituted quinolin-2-yl. Most preferred is that Z1, Z2 and Z4 each represent optionally substituted pyridin-2-yl.

The groups Z1, Z2 and Z4 if substituted, are preferably substituted by a group selected from C₁₋₄-alkyl, aryl, arylalkyl, heteroaryl, methoxy, hydroxy, nitro, amino, carboxyl, halo, and carbonyl. Preferred is that Z1, Z2 and Z4 are each substituted by a methyl group. Also, we prefer that the Z1 groups represent identical groups.

Each Q1 preferably represents a covalent bond or C1-C4-alkylene, more preferably a covalent bond, methylene or ethylene, most preferably a covalent bond.

Group Q preferably represents a covalent bond or C1-C4-alkylene, more preferably a covalent bond.

The groups R5, R6, R7, R8 preferably independently represent a group selected from —H, hydroxy-C₀-C₂₀-alkyl, halo-C₀-C₂₀-alkyl, nitroso, formyl-C₀-C₂₀-alkyl, carboxyl-C₀-C₂₀-alkyl and esters and salts thereof, carbamoyl-C₀-C₂₀-alkyl, sulfo-C₀-C₂₀-alkyl and esters and salts thereof, sulfamoyl-C₀-C₂₀-alkyl, amino-C₀-C₂₀-alkyl, aryl-C₀-C₂₀-alkyl, C₀-C₂₀-alkyl, alkoxy-C₀-C₈-alkyl, carbonyl-C₀-C₆-alkoxy, and C₀-C₂₀-alkylamide. Preferably, none of R5-R8 is linked together.

Non-coordinated group T preferably represents hydrogen, hydroxy, methyl, ethyl, benzyl, or methoxy.

In one aspect, the group U in formula (IA) represents a coordinating group of the general formula (IIA):

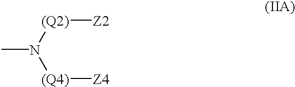

According to this aspect, it is preferred that Z2 represents an optionally substituted heterocyclic ring or an optionally substituted heteroaromatic ring selected from pyridine, pyrimidine, pyrazine, pyrazole, imidazole, benzimidazole, quinoline, quinoxaline, triazole, isoquinoline, carbazole, indole, isoindole, oxazole and thiazole, more preferably optionally substituted pyridin-2-yl or optionally substituted benzimidazol-2-yl.

It is also preferred, in this aspect, that Z4 represents an optionally substituted heterocyclic ring or an optionally substituted heteroaromatic ring selected from pyridine, pyrimidine, pyrazine, pyrazole, imidazole, benzimidazole, quinoline, quinoxaline, triazole, isoquinoline, carbazole, indole, isoindole, oxazole and thiazole, more preferably optionally substituted pyridin-2-yl, or an non-coordinating group selected from hydrogen, hydroxy, alkoxy, alkyl, alkenyl, cycloalkyl, aryl, or benzyl.

In preferred embodiments of this aspect, the ligand is selected from:

1,1-bis(pyridin-2-yl)-N-methyl-N-(pyridin-2-ylmethyl)methylamine;

1,1-bis(pyridin-2-yl)-N,N-bis(6-methyl-pyridin-2-ylmethyl)methylamine;

1,1-bis(pyridin-2-yl)-N,N-bis(5-carboxymethyl-pyridin-2-ylmethyl)methylamine;

1,1-bis(pyridin-2-yl)-1-benzyl-N,N-bis(pyridin-2-ylmethyl)methylamine; and

1,1-bis(pyridin-2yl)-N,N-bis(benzimidazol-2-ylmethyl)methylamine.

In a variant of this aspect, the group Z4 in formula (IIA) represents a group of the general formula (IIAa):

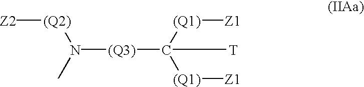

In this variant, Q4 preferably represents optionally substituted alkylene, preferably —CH₂—CHOH—CH₂— or —CH₂—CH₂—CH₂—. In a preferred embodiment of this variant, the ligand is:

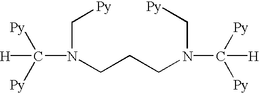

wherein —Py represents pyridin-2-yl.

In another aspect, the group U in formula (IA) represents a coordinating group of the general formula (IIIA):

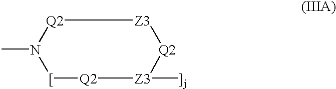

wherein j is 1 or 2, preferably 1.

According to this aspect, each Q2 preferably represents —(CH₂)ₙ— (n=2-4), and each Z3 preferably represents —N(R)— wherein R=—H or C₁₋₄-alkyl, preferably methyl.

In preferred embodiments of this aspect, the ligand is selected from:

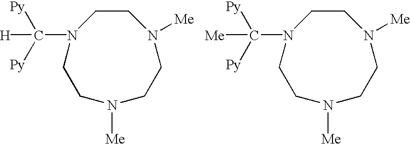

wherein -Py represents pyridin-2-yl.

In yet another aspect, the group U in formula (IA) represents a coordinating group of the general formula (IVA):

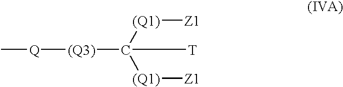

In this aspect, Q preferably represents —N(T)- (wherein T=—H, methyl, or benzyl) or pyridin-diyl.

In preferred embodiments of this aspect, the ligand is selected from:

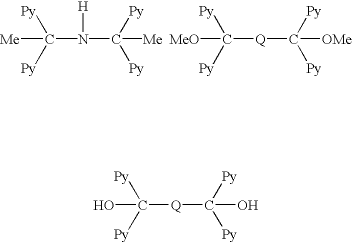

wherein -Py represents pyridin-2-yl, and -Q- represents pyridin-2,6-diyl.

(B) Ligands of the general formula (IB):

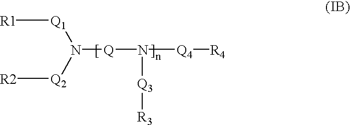

wherein

n=1 or 2, whereby if n=2, then each -Q₃-R₃ group is independently defined;

R₁, R₂, R₃, R₄ independently represent a group selected from hydrogen, hydroxyl, halogen, —NH—C(NH)NH₂, —R and —OR, wherein R=alkyl, alkenyl, cycloalkyl, heterocycloalkyl, aryl, heteroaryl or a carbonyl derivative group, R being optionally substituted by one or more functional groups E,

Q₁, Q₂, Q₃, Q₄ and Q independently represent a group of the formula:

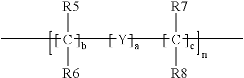

wherein

5≧a+b+c≧1; a=0-5; b=0-5; c=0-5; n=1 or 2;

Y independently represents a group selected from —O—, —S—, —SO—, —SO₂—, —C(O)—, arylene, alkylene, heteroarylene, heterocycloalkylene, -(G)P—, —P(O)— and -(G)N—, wherein G is selected from hydrogen, alkyl, aryl, arylalkyl, cycloalkyl, each except hydrogen being optionally substituted by one or more functional groups E;

R5, R6, R7, R8 independently represent a group selected from hydrogen, hydroxyl, halogen, —R and —OR, wherein R represents alkyl, alkenyl, cycloalkyl, heterocycloalkyl, aryl, heteroaryl or a carbonyl derivative group, R being optionally substituted by one or more functional groups E,

or R5 together with R6, or R7 together with R8, or both, represent oxygen,

or R5 together with R7 and/or independently R6 together with R8, or R5 together with R8 and/or independently R6 together with R7, represent C₁₋₆-alkylene optionally substituted by C₁₋₄-alkyl, —F, —Cl, —Br or —I,

provided that at least two of R₁, R₂, R₃, R₄ comprise coordinating heteroatoms and no more than six heteroatoms are coordinated to the same transition metal atom.

At least two, and preferably at least three, of R₁, R₂, R₃, R₄ independently represent a group selected from carboxylate, amido, —NH—C(NH)NH₂, hydroxyphenyl, an optionally substituted heterocyclic ring or an optionally substituted heteroaromatic ring selected from pyridine, pyrimidine, pyrazine, pyrazole, imidazole, benzimidazole, quinoline, quinoxaline, triazole, isoquinoline, carbazole, indole, isoindole, oxazole and thiazole. Preferably, substituents for groups R₁, R₂, R₃, R₄, when representing a heterocyclic or heteroaromatic ring, are selected from C₁₋₄-alkyl, aryl, arylalkyl, heteroaryl, methoxy, hydroxy, nitro, amino, carboxyl, halo, and carbonyl.

The groups Q₁, Q₂, Q₃, Q₄ preferably independently represent a group selected from —CH₂— and —CH₂CH₂—.

Group Q is preferably a group selected from —(CH₂)₂₋₄—, —CH₂CH(OH)CH₂—,

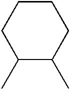

optionally substituted by methyl or ethyl,

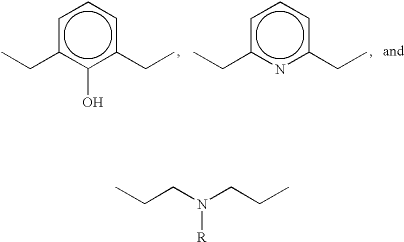

wherein R represents —H or C₁₋₄-alkyl.

Preferably, Q₁, Q₂, Q₃, Q₄ are defined such that a=b=0, c=1 and n=1, and Q is defined such that a=b=0, c=2 and n=1.

The groups R5, R6, R7, R8 preferably independently represent a group selected from —H, hydroxy-C₀-C₂₀-alkyl, halo-C₀-C₂₀-alkyl, nitroso, formyl-C₀-C₂₀-alkyl, carboxyl-C₀-C₂₀-alkyl and esters and salts thereof, carbamoyl-C₀-C₂₀-alkyl, sulfo-C₀-C₂₀-alkyl and esters and salts thereof, sulfamoyl-C₀-C₂₀-alkyl, amino-C₀-C₂₀-alkyl, aryl-C₀-C₂₀-alkyl, C₀-C₂₀-alkyl, alkoxy-C₀-C₈-alkyl, carbonyl-C₀-C₆-alkoxy, and C₀-C₂₀-alkylamide. Preferably, none of R5-R8 is linked together.

In a preferred aspect, the ligand is of the general formula (IIB):

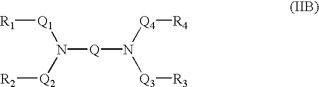

wherein

Q₁, Q₂, Q₃, Q₄ are defined such that a=b=0, c=1 or 2 and n=1;

Q is defined such that a=b=b 0, c=2,3 or 4 and n=1; and

R₁, R₂, R₃, R₄, R7, R8 are independently defined as for formula (I).

Preferred classes of ligands according to this aspect, as represented by formula (IIB) above, are as follows:

(i) ligands of the general formula (IIB) wherein:

R₁, R₂, R₃, R₄ each independently represent a coordinating group selected from carboxylate, amido, —NH—C(NH)NH₂, hydroxyphenyl, an optionally substituted heterocyclic ring or an optionally substituted heteroaromatic ring selected from pyridine, pyrimidine, pyrazine, pyrazole, imidazole, benzimidazole, quinoline, quinoxaline, triazole, isoquinoline, carbazole, indole, isoindole, oxazole and thiazole.

In this class, we prefer that:

Q is defined such that a=b=0, c=2 or 3 and n=1;

R₁, R₂, R₃, R₄ each independently represent a coordinating group selected from optionally substituted pyridin-2-yl, optionally substituted imidazol-2-yl, optionally substituted imidazol-4-yl, optionally substituted pyrazol-1-yl, and optionally substituted quinolin-2-yl.

(ii) ligands of the general formula (IIB) wherein:

R₁, R₂, R₃ each independently represent a coordinating group selected from carboxylate, amido, —NH—C(NH)NH₂, hydroxyphenyl, an optionally substituted heterocyclic ring or an optionally substituted heteroaromatic ring selected from pyridine, pyrimidine, pyrazine, pyrazole, imidazole, benzimidazole, quinoline, quinoxaline, triazole, isoquinoline, carbazole, indole, isoindole, oxazole and thiazole; and

R₄ represents a group selected from hydrogen, C₁₋₂₀ optionally substituted alkyl, C₁₋₂₀ optionally substituted arylalkyl, aryl, and C₁₋₂₀ optionally substituted NR₃⁺ (wherein R=C₁₋₈-alkyl).

In this class, we prefer that:

Q is defined such that a=b=0, c=2 or 3 and n=1;

R₁, R₂, R₃ each independently represent a coordinating group selected from optionally substituted pyridin-2-yl, optionally substituted imidazol-2-yl, optionally substituted imidazol-4-yl, optionally substituted pyrazol-1-yl, and optionally substituted quinolin-2-yl; and

R₄ represents a group selected from hydrogen, C₁₋₁₀ optionally substituted alkyl, C₁₋₅-furanyl, C₁₋₅ optionally substituted benzylalkyl, benzyl, C₁₋₅ optionally substituted alkoxy, and C₁₋₂₀ optionally substituted N⁺Me₃.

(iii) ligands of the general formula (IIB) wherein:

R₁, R₄ each independently represent a coordinating group selected from carboxylate, amido, —NH—C(NH)NH₂, hydroxyphenyl, an optionally substituted heterocyclic ring or an optionally substituted heteroaromatic ring selected from pyridine, pyrimidine, pyrazine, pyrazole, imidazole, benzimidazole, quinoline, quinoxaline, triazole, isoquinoline, carbazole, indole, isoindole oxazole and thiazole; and

R₂, R₃ each independently represent a group selected from hydrogen, C₁₋₂₀ optionally substituted alkyl, C₁₋₂₀ optionally substituted arylalkyl, aryl, and C₁₋₂₀ optionally substituted NR₃⁺ (wherein R=C₁₋₈-alkyl).

In this class, we prefer that:

Q is defined such that a=b=0, c=2 or 3 and n=1;

R₁, R₄ each independently represent a coordinating group selected from optionally substituted pyridin-2-yl, optionally substituted imidazol-2-yl, optionally substituted imidazol-4-yl, optionally substituted pyrazol-1-yl, and optionally substituted quinolin-2-yl; and

R₂, R₃ each independently represent a group selected from hydrogen, C₁₋₁₀ optionally substituted alkyl, C₁₋₅-furanyl, C₁₋₅ optionally substituted benzylalkyl, benzyl, C₁₋₅ optionally substituted alkoxy, and C₁₋₂₀ optionally substituted N⁺Me₃.

Examples of preferred ligands in their simplest forms are:

N,N′,N′-tris(3-methyl-pyridin-2-ylmethyl)-ethylenediamine;

N-trimethylammoniumpropyl-N,N′,N′-tris(pyridin-2-ylmethyl)-ethylenediamine;

N-(2-hydroxyethylene)-N,N′,N′-tris(pyridin-2-ylmethyl)-ethylenediamine;

N,N,N′,N′-tetrakis(3-methyl-pyridin-2-ylmethyl)-ethylene-diamine;

N,N′-dimethyl-N,N′-bis(pyridin-2-ylmethyl)-cyclohexane-1,2-diamine;

N-(2-hydroxyethylene)-N,N′,N′-tris(3-methyl-pyridin-2-ylmethyl)-ethylenediamine;

N-methyl-N,N′,N′-tris(pyridin-2-ylmethyl)-ethylenediamine;

N-methyl-N,N′,N′-tris(5-ethyl-pyridin-2-ylmethyl)-ethylenediamine;

N-methyl-N,N′,N′-tris(5-methyl-pyridin-2-ylmethyl)-ethylenediamine;

N-methyl-N,N′,N′-tris(3-methyl-pyridin-2-ylmethyl)-ethylenediamine;

N-benzyl-N,N′,N′-tris(3-methyl-pyridin-2-ylmethyl)-ethylenediamine;

N-ethyl-N,N′, N′-tris(3-methyl-pyridin-2-ylmethyl)-ethylenediamine;

N,N,N′-tris(3-methyl-pyridin-2-ylmethyl)-N′(2′-methoxy-ethyl-1)-ethylenediamine;

N,N,N′-tris(1-methyl-benzimidazol-2-yl)-N′-methyl-ethylenediamine;

N-(furan-2-yl)-N,N′,N′-tris(3-methyl-pyridin-2-ylmethyl)-ethylenediamine;

N-(2-hydroxyethylene)-N,N′,N′-tris(3-ethyl-pyridin-2-ylmethyl)-ethylenediamine;

N-methyl-N,N′,N′-tris(3-methyl-pyridin-2-ylmethyl)ethylene-1,2-diamine;

N-ethyl-N,N′,N′-tris(3-methyl-pyridin-2-ylmethyl)ethylene-1,2-diamine;

N-benzyl-N,N′,N′-tris(3-methyl-pyridin-2-ylmethyl)ethylene-1,2-diamine;

N-(2-hydroxyethyl)-N,N′,N′-tris(3-methyl-pyridin-2-ylmethyl)ethylene-1,2-diamine;

N-(2-methoxyethyl)-N,N′,N′-tris(3-methyl-pyridin-2-ylmethyl)ethylene-1,2-diamine;

N-methyl-N,N′,N′-tris(5-methyl-pyridin-2-ylmethyl)ethylene-1,2-diamine;

N-ethyl-N,N′,N′-tris(5-methyl-pyridin-2-ylmethyl)ethylene-1,2-diamine;

N-benzyl-N,N′,N′-tris(5-methyl-pyridin-2-ylmethyl)ethylene-1,2-diamine;

N-(2-hydroxyethyl)-N,N′,N′-tris(5-methyl-pyridin-2-ylmethyl)ethylene-1,2-diamine;

N-(2-methoxyethyl)-N,N′,N′-tris(5-methyl-pyridin-2-ylmethyl)ethylene-1,2-diamine;

N-methyl-N,N′,N′-tris(3-ethyl-pyridin-2-ylmethyl)ethylene-1,2-diamine;

N-benzyl-N,N′,N′-tris(3-ethyl-pyridin-2-ylmethyl)ethylene-1,2-diamine;

N-(2-methoxyethyl)-N,N′,N′-tris(3-ethyl-pyridin-2-ylmethyl)ethylene-1,2-diamine;

N-methyl-N,N′,N′-tris(5-ethyl-pyridin-2-ylmethyl)ethylene-1,2-diamine;

N-ethyl-N,N′,N′-tris(5-ethyl-pyridin-2-ylmethyl)ethylene-1,2-diamine;

N-benzyl-N,N′,N′-tris(5-ethyl-pyridin-2-ylmethyl)ethylene-1,2-diamine; and

N-(2-methoxyethyl)-N,N′,N′-tris(5-ethyl-pyridin-2-ylmethyl)ethylene-1,2-diamine.

More preferred ligands are:

N-methyl-N,N′,N′-tris(3-methyl-pyridin-2-yl methyl)ethylene-1,2-diamine;

N-ethyl- N,N′,N′-tris(3-methyl-pyridin-2-ylmethyl)ethylene-1,2-diamine;

N-benzyl-N,N′,N′-tris(3-methyl-pyridin-2-ylmethyl)ethylene-1,2-diamine;

N-(2-hydroxyethyl)-N,N′,N′-tris(3-methyl -pyridin-2-ylmethyl)ethylene-1,2-diamine; and

N-(2-methoxyethyl)-N,N′,N′-tris(3-methyl-pyridin-2-ylmethyl)ethylene-1,2-diamine.

(C) Ligands of the general formula (IC):

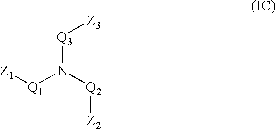

wherein

Z₁, Z₂ and Z₃ independently represent a coordinating group selected from carboxylate, amido, —NH—C(NH)NH₂, hydroxyphenyl, an optionally substituted heterocyclic ring or an optionally substituted heteroaromatic ring selected from pyridine, pyrimidine, pyrazine, pyrazole, imidazole, benzimidazole, quinoline, quinoxaline, triazole, isoquinoline, carbazole, indole, isoindole, oxazole and thiazole;

Q₁, Q₂, and Q₃ independently represent a group of the formula:

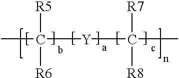

wherein

5≧a+b+c≧1; a=0-5; b=0-5; c=0-5; n=1 or 2;

Y independently represents a group selected from —O—, —S—, —SO—, —SO₂—, —C(O)—, arylene, alkylene, heteroarylene, heterocycloalkylene, —(G)P—, —P(O)— and -(G)N—, wherein G is selected from hydrogen, alkyl, aryl, arylalkyl, cycloalkyl, each except hydrogen being optionally substituted by one or more functional groups E; and

R5, R6, R7, R8 independently represent a group selected from hydrogen, hydroxyl, halogen, —R and —OR, wherein R represents alkyl, alkenyl, cycloalkyl, heterocycloalkyl, aryl, heteroaryl or a carbonyl derivative group, R being optionally substituted by one or more functional groups E,

or R5 together with R6, or R7 together with R8, or both, represent oxygen,

or R5 together with R7 and/or independently R6 together with R8, or R5 together with R8 and/or independently R6 together with R7, represent C₁₋₆-alkylene optionally substituted by C₁₋₄-alkyl, —F, —Cl, —Br or —I.

Z₁, Z₂ and Z₃ each represent a coordinating group, preferably selected from optionally substituted pyridin-2-yl, optionally substituted imidazol-2-yl, optionally substituted imidazol-4-yl, optionally substituted pyrazol-1-yl, and optionally substituted quinolin-2-yl. Preferably, Z₁, Z₂ and Z₃ each represent optionally substituted pyridin-2-yl.

Optional substituents for the groups Z₁, Z₂ and Z₃ are preferably selected from C₁₋₄-alkyl, aryl, arylalkyl, heteroaryl, methoxy, hydroxy, nitro, amino, carboxyl, halo, and carbonyl, preferably methyl.

Also preferred is that Q₁, Q₂ and Q₃ are defined such that a=b=0, c=1 or 2, and n=1.

Preferably, each Q₁, Q₂ and Q₃ independently represent C₁-C₄-alkylene, more preferably a group selected from —CH₂— and —CH₂CH₂—.

The groups R5, R6, R7, R8 preferably independently represent a group selected from —H, hydroxy-C₀-C₂₀-alkyl, halo-C₀-C₂₀-alkyl, nitroso, formyl-C₀-C₂₀-alkyl, carboxyl-C₀-C₂₀-alkyl and esters and salts thereof, carbamoyl-C₀-C₂₀-alkyl, sulfo-C₀-C₂₀-alkyl and esters and salts thereof, sulfamoyl-C₀-C₂₀-alkyl, amino-C₀-C₂₀-alkyl, aryl-C₀-C₂₀-alkyl, C₀-C₂₀-alkyl, alkoxy-C₀-C₈-alkyl, carbonyl-C₀-C₆-alkoxy, and C₀-C₂₀-alkylamide. Preferably, none of R5-R8 is linked together.

Preferably, the ligand is selected from tris(pyridin-2-ylmethyl)amine, tris(3-methyl-pyridin-2-ylmethyl)amine, tris(5-methyl-pyridin-2-ylmethyl)amine, and tris(6-methyl-pyridin-2-ylmethyl)amine.

(D) Ligands of the general formula (ID):

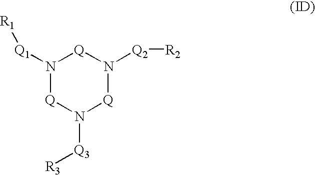

wherein

R₁, R₂, and R₃ independently represent a group selected from hydrogen, hydroxyl, halogen, —NH—C(NH)NH₂, —R and —OR, wherein R=alkyl, alkenyl, cycloalkyl, heterocycloalkyl, aryl, heteroaryl or a carbonyl derivative group, R being optionally substituted by one or more functional groups E;

Q independently represent a group selected from C₂₋₃-alkylene optionally substituted by H, benzyl or C₁₋₈-alkyl;

Q₁, Q₂ and Q₃ independently represent a group of the formula:

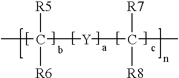

wherein

5≧a+b+c≧1; a=0-5; b=0-5; c=0-5; n=1 or 2;

Y independently represents a group selected from —O—, —S—, —SO—, —SO₂—, —C(O)—, arylene, alkylene, heteroarylene, heterocycloalkylene, -(G)P—, —P(O)— and -(G)N—, wherein G is selected from hydrogen, alkyl, aryl, arylalkyl, cycloalkyl, each except hydrogen being optionally substituted by one or more functional groups E; and

R5, R6, R7, R8 independently represent a group selected from hydrogen, hydroxyl, halogen, —R and —OR, wherein R represents alkyl, alkenyl, cycloalkyl, heterocycloalkyl, aryl, heteroaryl or a carbonyl derivative group, R being optionally substituted by one or more functional groups E,

or R5 together with R6, or R7 together with R8, or both, represent oxygen,

or R5 together with R7 and/or independently R6 together with R8, or R5 together with R8 and/or independently R6 together with R7, represent C₁₋₆-alkylene optionally substituted by C₁₋₄-alkyl, —F, —Cl, —Br or —I,

provided that at least one, preferably at least two, of R₁, R₂ and R₃ is a coordinating group.

At least two, and preferably at least three, of R₁, R₂ and R₃ independently represent a group selected from carboxylate, amido, —NH—C(NH)NH₂, hydroxyphenyl, an optionally substituted heterocyclic ring or an optionally substituted heteroaromatic ring selected from pyridine, pyrimidine, pyrazine, pyrazole, imidazole, benzimidazole, quinoline, quinoxaline, triazole, isoquinoline, carbazole, indole, isoindole, oxazole and thiazole. Preferably, at least two of R₁, R₂, R₃ each independently represent a coordinating group selected from optionally substituted pyridin-2-yl, optionally substituted imidazol-2-yl, optionally substituted imidazol-4-yl, optionally substituted pyrazol-1-yl, and optionally substituted quinolin-2-yl.

Preferably, substituents for groups R₁, R₂, R₃, when representing a heterocyclic or heteroaromatic ring, are selected from C₁₋₄-alkyl, aryl, arylalkyl, heteroaryl, methoxy, hydroxy, nitro, amino, carboxyl, halo, and carbonyl.

Preferably, Q₁, Q₂ and Q₃ are defined such that a=b=0, c=1,2,3 or 4 and n=1. Preferably, the groups Q₁, Q₂ and Q₃ independently represent a group selected from —CH₂— and —CH₂CH₂—.

Group Q is preferably a group selected from —CH₂CH₂— and —CH₂CH₂CH₂—.

The groups R5, R6, R7, R8 preferably independently represent a group selected from —H, hydroxy-C₀-C₂₀-alkyl, halo-C₀-C₂₀-alkyl, nitroso, formyl-C₀-C₂₀-alkyl, carboxyl-C₀-C₂₀-alkyl and esters and salts thereof, carbamoyl-C₀-C₂₀-alkyl, sulfo-C₀-C₂₀-alkyl and esters and salts thereof, sulfamoyl-C₀-C₂₀-alkyl, amino-C₀-C₂₀-alkyl, aryl-C₀-C₂₀-alkyl, C₀-C₂₀-alkyl, alkoxy-C₀-C₈-alkyl, carbonyl-C₀-C₆-alkoxy, and C₀-C₂₀-alkylamide. Preferably, none of R5-R8 is linked together.

In a preferred aspect, the ligand is of the general formula (IID):

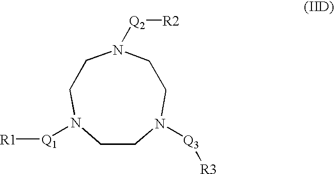

wherein R1, R2, R3 are as defined previously for R₁, R₂, R₃, and Q₁, Q₂, Q₃ are as defined previously.

Preferred classes of ligands according to this preferred aspect, as represented by formula (IID) above, are as follows:

(i) ligands of the general formula (IID) wherein:

R1, R2, R3 each independently represent a coordinating group selected from carboxylate, amido, —NH—C(NH)NH₂, hydroxyphenyl, an optionally substituted heterocyclic ring or an optionally substituted heteroaromatic ring selected from pyridine, pyrimidine, pyrazine, pyrazole, imidazole, benzimidazole, quinoline, quinoxaline, triazole, isoquinoline, carbazole, indole, isoindole, oxazole and thiazole.

In this class, we prefer that:

R1, R2, R3 each independently represent a coordinating group selected from optionally substituted pyridin-2-yl, optionally substituted imidazol-2-yl, optionally substituted imidazol-4-yl, optionally substituted pyrazol-1-yl, and optionally substituted quinolin-2-yl.

(ii) ligands of the general formula (IID) wherein:

two of R1, R2, R3 each independently represent a coordinating group selected from carboxylate, amido, —NH—C(NH)NH₂, hydroxyphenyl, an optionally substituted heterocyclic ring or an optionally substituted heteroaromatic ring selected from pyridine, pyrimidine, pyrazine, pyrazole, imidazole, benzimidazole, quinoline, quinoxaline, triazole, isoquinoline, carbazole, indole, isoindole, oxazole and thiazole; and

one of R1, R2, R3 represents a group selected from hydrogen, C₁₋₂₀ optionally substituted alkyl, C₁₋₂₀ optionally substituted arylalkyl, aryl, and C₁₋₂₀ optionally substituted NR₃⁺ (wherein R=C₁₋₈-alkyl).

In this class, we prefer that:

two of R1, R2, R3 each independently represent a coordinating group selected from optionally substituted pyridin-2-yl, optionally substituted imidazol-2-yl, optionally substituted imidazol-4-yl, optionally substituted pyrazol-1-yl, and optionally substituted quinolin-2-yl; and

one of R1, R2, R3 represents a group selected from hydrogen, C₁₋₁₀ optionally substituted alkyl, C₁₋₅-furanyl, C₁₋₅ optionally substituted benzylalkyl, benzyl, C₁₋₅ optionally substituted alkoxy, and C₁₋₂₀ optionally substituted N⁺Me₃.

In especially preferred embodiments, the ligand is selected from:

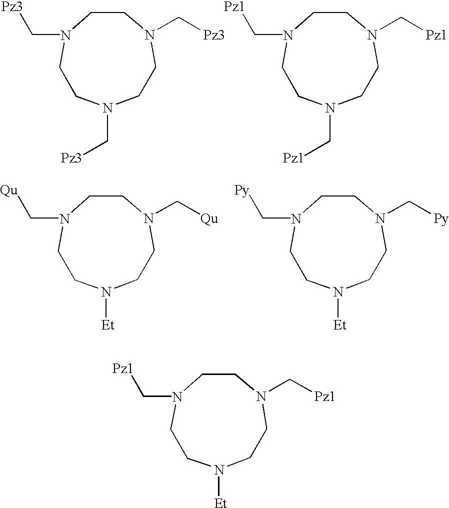

wherein -Et represents ethyl, —Py represents pyridin-2-yl, Pz3 represents pyrazol-3-yl, Pz1 represents pyrazol-1-yl, and Qu represents quinolin-2-yl.

(E) Ligands of the general formula (IE):

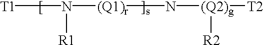

wherein

g represents zero or an integer from 1 to 6;

r represents an integer from 1 to 6;

s represents zero or an integer from 1 to 6;

Q1 and Q2 independently represent a group of the formula:

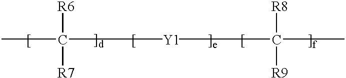

wherein

5≧d+e+f≧1; d=0-5; e=0-5; f=0-5;

each Y1 independently represents a group selected from —O—, —S—, —SO—, —SO₂—, —C(O)—, arylene, alkylene, heteroarylene, heterocycloalkylene, -(G)P—, —P(O)— and -(G)N—, wherein G is selected from hydrogen, alkyl, aryl, arylalkyl, cycloalkyl, each except hydrogen being optionally substituted by one or more functional groups E;

if s>1, each -[—N(R1)-(Q1)ᵣ-]- group is independently defined;

R1, R2, R6, R7, R8, R9 independently represent a group selected from hydrogen, hydroxyl, halogen, —R and —OR, wherein R represents alkyl, alkenyl, cycloalkyl, heterocycloalkyl, aryl, heteroaryl or a carbonyl derivative group, R being optionally substituted by one or more functional groups E,

or R6 together with R7, or R8 together with R9, or both, represent oxygen,

or R6 together with R8 and/or independently R7 together with R9, or R6 together with R9 and/or independently R7 together with R8, represent C₁₋₆-alkylene optionally substituted by C₁₋₄-alkyl, —F, —Cl, —Br or —I;

or one of R1-R9 is a bridging group bound to another moiety of the same general formula;

T1 and T2 independently represent groups R4 and R5, wherein R4 and R5 are as defined for R1-R9, and if g=0 and s>0, R1 together with R4, and/or R2 together with R5, may optionally independently represent═CH—R10, wherein R10 is as defined for R1-R9, or

T1 and T2 may together (-T2-T1-) represent a covalent bond linkage when s>1 and g>0;

if T1 and T2 together represent a single bond linkage, Q1 and/or Q2 may independently represent a group of the formula:

═CH—[—Y1—]ₑ—CH═

provided R1 and/or R2 are absent, and R1 and/or R2 may be absent provided Q1 and/or Q2 independently represent a group of the formula:

═CH—[—Y1—]ₑ—CH═.

The groups R1-R9 are preferably independently selected from —H, hydroxy-C₀-C₂₀-alkyl, halo-C₀-C₂₀-alkyl, nitroso, formyl-C₀-C₂₀-alkyl, carboxyl-C₀-C₂₀-alkyl and esters and salts thereof, carbamoyl-C₀-C₂₀-alkyl, sulpho-C₀-C₂₀-alkyl and esters and salts thereof, sulphamoyl-C₀-C₂₀-alkyl, amino-C₀-C₂₀-alkyl, aryl-C₀-C₂₀-alkyl, heteroaryl-C₀-C₂₀-alkyl, C₀-C₂₀-alkyl, alkoxy-C₀-C₈-alkyl, carbonyl-C₀-C₆-alkoxy, and aryl-C₀-C₆-alkyl and C₀-C₂₀-alkylamide.

One of R1-R9 may be a bridging group which links the ligand moiety to a second ligand moiety of preferably the same general structure. In this case the bridging group is independently defined according to the formula for Q1, Q2, preferably being alkylene or hydroxy-alkylene or a heteroaryl-containing bridge, more preferably C₁₋₆-alkylene optionally substituted by C₁₋₄-alkyl, —F, —Cl, —Br or —I.

In a first variant according to formula (IE), the groups T1 and T2 together form a single bond linkage and s>1, according to general formula (IIE):

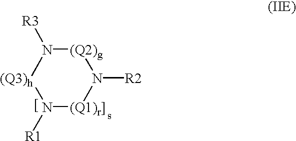

wherein R3 independently represents a group as defined for R1-R9; Q3 independently represents a group as defined for Q1, Q2; h represents zero or an integer from 1 to 6; and s=s−1.

In a first embodiment of the first variant, in general formula (IIE), s=1, 2 or 3; r=g=h=1; d=2 or 3; e=f=0; R6=R7=H, preferably such that the ligand has a general formula selected from:

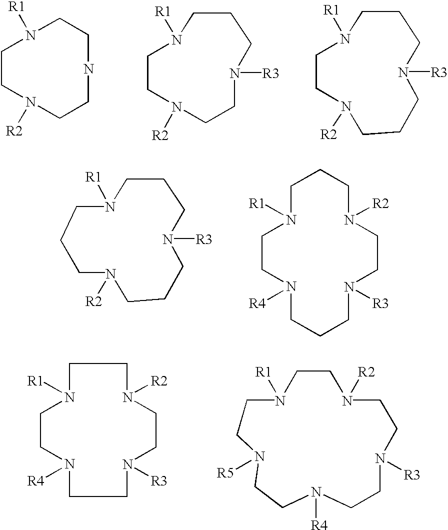

In these preferred examples, R1, R2, R3 and R4 are preferably independently selected from —H, alkyl, aryl, heteroaryl, and/or one of R1-R4 represents a bridging group bound to another moiety of the same general formula and/or two or more of R1-R4 together represent a bridging group linking N atoms in the same moiety, with the bridging group being alkylene or hydroxy-alkylene or a heteroaryl-containing bridge, preferably heteroarylene. More preferably, R1, R2, R3 and R4 are independently selected from —H, methyl, ethyl, isopropyl, nitrogen-containing heteroaryl, or a bridging group bound to another moiety of the same general formula or linking N atoms in the same moiety with the bridging group being alkylene or hydroxy-alkylene.

In a second embodiment of the first variant, in general formula (IIE), s=2 and r=g=h=1, according to the general formula:

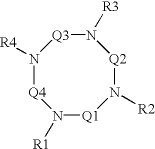

In this second embodiment, preferably R1-R4 are absent; both Q1 and Q3 represent ═CH—[—Y1—]ₑ—CH═; and both Q2 and Q4 represent —CH₂—[—Y1—]ₙ—CH₂—.

Thus, preferably the ligand has the general formula:

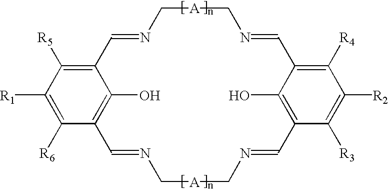

wherein A represents optionally substituted alkylene optionally interrupted by a heteroatom; and n is zero or an integer from 1 to 5.

Preferably, R1-R6 represent hydrogen, n=1 and A=—CH₂—, —CHOH—, —CH₂N(R)CH₂— or —CH₂CH₂N(R)CH₂CH₂— wherein R represents hydrogen or alkyl, more preferably A=—CH₂—, —CHOH— or —CH₂CH₂NHCH₂CH₂—.

In a second variant according to formula (IE), T1 and T2 independently represent groups R4, R5 as defined for R1-R9, according to the general formula (IIIE):

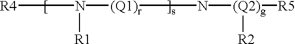

In a first embodiment of the second variant, in general formula (IIIE), s=1; r=1; g=0; d=f=1; e=0-4; Y1=—CH₂—; and R1 together with R4, and/or R2 together with R5, independently represent ═CH—R10, wherein R10 is as defined for R1-R9. In one example, R2 together with R5 represents ═CH—R10, with R1 and R4 being two separate groups. Alternatively, both R1 together with R4, and R2 together with R5 may independently represent ═CH—R10. Thus, preferred ligands may for example have a structure selected from:

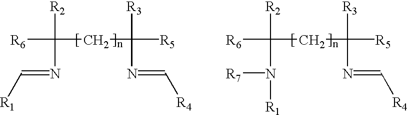

wherein n=0-4.

Preferably, the ligand is selected from:

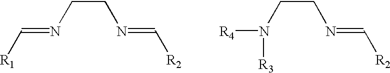

wherein R1 and R2 are selected from optionally substituted phenols, heteroaryl-C₀-C₂₀-alkyls, R3 and R4 are selected from —H, alkyl, aryl, optionally substituted phenols, heteroaryl-C₀-C₂₀-alkyls, alkylaryl, aminoalkyl, alkoxy, more preferably R1 and R2 being selected from optionally substituted phenols, heteroaryl-C₀-C₂-alkyls, R3 and R4 are selected from —H, alkyl, aryl, optionally substituted phenols, nitrogen-heteroaryl-C₀-C₂-alkyls.

In a second embodiment of the second variant, in general formula (IIIE), s=1; r=1; g=0; d=f=1; e=1-4; Y1=—C(R′)(R″), wherein R′ and R″ are independently as defined for R1-R9. Preferably, the ligand has the general formula:

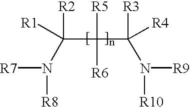

The groups R1, R2, R3, R4, R5 in this formula are preferably —H or C₀-C₂₀-alkyl, n=0 or 1, R6 is —H, alkyl, —OH or —SH, and R7, R8, R9, R10 are preferably each independently selected from —H, C₀-C₂₀-alkyl, heteroaryl-C₀-C₂₀-alkyl, alkoxy-C₀-C₈-alkyl and amino-C₀-C₂₀-alkyl.

In a third embodiment of the second variant, in general formula (IIIE), s=0; g=1; d=e=0; f=1-4. Preferably, the ligand has the general formula:

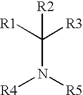

This class of ligand is particularly preferred according to the invention.

More preferably, the ligand has the general formula:

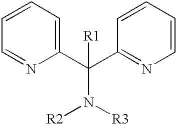

wherein R1, R2, R3 are as defined for R2, R4, R5.

In a fourth embodiment of the second variant, the ligand is a pentadentate ligand of the general formula (IVE):

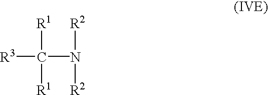

wherein

each R¹, R² independently represents —R⁴—R⁵,

R³ represents hydrogen, optionally substituted alkyl, aryl or arylalkyl, or —R⁴—R⁵,

each R⁴ independently represents a single bond or optionally substituted alkylene, alkenylene, oxyalkylene, aminoalkylene, alkylene ether, carboxylic ester or carboxylic amide, and

each R⁵ independently represents an optionally N-substituted aminoalkyl group or an optionally substituted heteroaryl group selected from pyridinyl, pyrazinyl, pyrazolyl, pyrrolyl, imidazolyl, benzimidazolyl, pyrimidinyl, triazolyl and thiazolyl.

Ligands of the class represented by general formula (IVE) are also particularly preferred according to the invention. The ligand having the general formula (IVE), as defined above, is a pentadentate ligand. By ‘pentadentate’ herein is meant that five hetero atoms can coordinate to the metal M ion in the metal-complex.

In formula (IVE), one coordinating hetero atom is provided by the nitrogen atom in the methylamine backbone, and preferably one coordinating hetero atom is contained in each of the four R¹ and R² side groups. Preferably, all the coordinating hetero atoms are nitrogen atoms.

The ligand of formula (IVE) preferably comprises at least two substituted or unsubstituted heteroaryl groups in the four side groups. The heteroaryl group is preferably a pyridin-2-yl group and, if substituted, preferably a methyl- or ethyl-substituted pyridin-2-yl group. More preferably, the heteroaryl group is an unsubstituted pyridin-2-yl group. Preferably, the heteroaryl group is linked to methylamine, and preferably to the N atom thereof, via a methylene group. Preferably, the ligand of formula (IVE) contains at least one optionally substituted amino-alkyl side group, more preferably two amino-ethyl side groups, in particular 2-(N-alkyl)amino-ethyl or 2-(N,N-dialkyl)amino-ethyl.

Thus, in formula (IVE) preferably R¹ represents pyridin-2-yl or R² represents pyridin-2-yl-methyl. Preferably R² or R¹ represents 2-amino-ethyl, 2-(N-(m)ethyl)amino-ethyl or 2-(N,N-di(m)ethyl)amino-ethyl. If substituted, R⁵ preferably represents 3-methyl pyridin-2-yl. R³ preferably represents hydrogen, benzyl or methyl.

Examples of preferred ligands of formula (IVE) in their simplest forms are:

(i) pyridin-2-yl containing ligands such as:

N,N-bis(pyridin-2-yl-methyl)-bis(pyridin-2-yl)methylamine;

N,N-bis(pyrazol-1-yl-methyl)-bis(pyridin-2-yl)methylamine;

N,N-bis(imidazol-2-yl-methyl)-bis(pyridin-2-yl)methylamine;

N,N-bis(1,2,4-triazol-1-yl-methyl)-bis(pyridin-2-yl)methylamine;

N,N-bis(pyridin-2-yl-methyl)-bis(pyrazol-1-yl)methylamine;

N,N-bis(pyridin-2-yl-methyl)-bis(imidazol-2-yl)methylamine;

N,N-bis(pyridin-2-yl-methyl)-bis(1,2,4-triazol-1-yl)methylamine;

N,N-bis(pyridin-2-yl-methyl)-1,1-bis(pyridin-2-yl)-1-aminoethane;

N,N-bis(pyridin-2-yl-methyl)-1,1-bis(pyridin-2-yl)-2-phenyl-1-aminoethane;

N,N-bis(pyrazol-1-yl-methyl)-1,1-bis(pyridin-2-yl)-1-aminoethane

N,N-bis(pyrazol-1-yl-methyl)-1,1-bis(pyridin-2-yl)-2-phenyl-1-aminoethane;

N,N-bis(imidazol-1-yl-methyl)-1,1-bis(pyridin-2-yl)-1-aminoethane

N,N-bis(imidazol-2-yl-methyl)-1,1-bis(pyridin-2-yl)-2-phenyl-1-aminoethane;

N,N-bis(1,2,4-triazol-1-yl-methyl)-1,1-bis(pyridin-2-yl)-1-aminoethane;

N,N-bis(1,2,4-triazol-1-yl-methyl)-1,1-bis(pyridin-2-yl)-2-phenyl-1-aminoethane;

N,N-bis(pyridin-2-yl-methyl)-1,1-bis(pyrazol-1-yl)-1-aminoethane;

N,N-bis(pyridin-2-yl-methyl)-1,1-bis(pyrazol-1-yl)-2-phenyl-1-aminoethane;

N,N-bis(pyridin-2-yl-methyl)-1,1-bis(imidazol-2-yl)-1-aminoethane;

N,N-bis(pyridin-2-yl-methyl)-1,1-bis(imidazol-2-yl)-2-phenyl-1-aminoethane;

N,N-bis(pyridin-2-yl-methyl)-1,1-bis(1,2,4-triazol-1-yl)-1-aminoethane;

N,N-bis(pyridin-2-yl-methyl)-1,1-bis(1,2,4-triazol-1-yl)-1-aminoethane;

N,N-bis(pyridin-2-yl-methyl)-1,1-bis(pyridin-2-yl)-1-aminoethane;

N,N-bis(pyridin-2-yl-methyl)-1,1-bis(pyridin-2-yl)-1-aminohexane;

N,N-bis(pyridin-2-yl-methyl)-1,1-bis(pyridin-2-yl)-2-phenyl-1-aminoethane;

N,N-bis(pyridin-2-yl-methyl)-1,1-bis(pyridin-2-yl)-2-(4-sulphonic acid-phenyl)-1-aminoethane;

N,N-bis(pyridin-2-yl-methyl)-1,1-bis(pyridin-2-yl)-2-(pyridin-2-yl)-1-aminoethane;

N,N-bis(pyridin-2-yl-methyl)-1,1-bis(pyridin-2-yl)-2-(pyridin-3-yl)-1-aminoethane;

N,N-bis(pyridin-2-yl-methyl)-1,1-bis(pyridin-2-yl)-2-(pyridin-4-yl)-1-aminoethane;

N,N-bis(pyridin-2-yl-methyl)-1,1-bis(pyridin-2-yl)-2-(1-alkyl-pyridinium-4-yl)-1-aminoethane;

N,N-bis(pyridin-2-yl-methyl)-1,1-bis(pyridin-2-yl)-2-(1-alkyl-pyridinium-3-yl)-1-aminoethane;

N,N-bis(pyridin-2-yl-methyl)-1,1-bis(pyridin-2-yl)-2-(1-alkyl-pyridinium-2-yl)-1-aminoethane;

(ii) 2-amino-ethyl containing ligands such as:

N,N-bis(2-(N-alkyl)amino-ethyl)-bis(pyridin-2-yl)methylamine;

N,N-bis(2-(N-alkyl)amino-ethyl)-bis(pyrazol-1-yl)methylamine;

N,N-bis(2-(N-alkyl)amino-ethyl)-bis(imidazol-2-yl)methylamine;

N,N-bis(2-(N-alkyl)amino-ethyl)-bis(1,2,4-triazol-1-yl) methylamine;

N,N-bis(2-(N,N-dialkyl)amino-ethyl)-bis(pyridin-2-yl)methylamine;

N,N-bis(2-(N,N-dialkyl)amino-ethyl)-bis(pyrazol-1-yl)methylamine;

N,N-bis(2-(N,N-dialkyl)amino-ethyl)-bis(imidazol-2-yl)methylamine;

N,N-bis(2-(N,N-dialkyl)amino-ethyl)-bis(1,2,4-triazol-1-yl)methylamine;

N,N-bis(pyridin-2-yl-methyl)- bis(2-amino-ethyl)methylamine:

N,N-bis(pyrazol-1-yl-methyl)-bis(2-amino-ethyl)methylamine:

N,N-bis(imidazol-2-yl-methyl)-bis(2-amino-ethyl)methylamine;

N,N-bis(1,2,4-triazol-1-yl-methyl)-bis(2-amino-ethyl)methylamine.

More preferred ligands are:

N,N-bis(pyridin-2-yl-methyl)-bis(pyridin-2-yl)methylamine, hereafter referred to as N4Py.

N,N-bis(pyridin-2-yl-methyl)-1,1-bis(pyridin-2-yl)-1-aminoethane, hereafter referred to as MeN4Py,

N,N-bis(pyridin-2-yl-methyl)-1,1-bis(pyridin-2-yl)-2-phenyl-1-aminoethane, hereafter referred to as BzN4Py.

In a fifth embodiment of the second variant, the ligand represents a pentadentate or hexadentate ligand of general formula (VE):

R¹R¹N—W—NR¹R² (VE)

wherein

each R¹ independently represents —R³—V, in which R³ represents optionally substituted alkylene, alkenylene, oxyalkylene, aminoalkylene or alkylene ether, and V represents an optionally substituted heteroaryl group selected from pyridinyl, pyrazinyl, pyrazolyl, pyrrolyl, imidazolyl, benzimidazolyl, pyrimidinyl, triazolyl and thiazolyl;

W represents an optionally substituted alkylene bridging group selected from —CH₂CH₂—, —CH₂CH₂CH₂—, —CH₂CH₂CH₂CH₂—, —CH₂—C₆H₄—CH₂, —CH₂—C₆H₁₀—CH₂—, and —CH₂—C₁₀H₆—CH₂—; and

R² represents a group selected from R¹, and alkyl, aryl and arylalkyl groups optionally substituted with a substituent selected from hydroxy, alkoxy, phenoxy, carboxylate, carboxamide, carboxylic ester, sulphonate, amine, alkylamine and N⁺(R⁴)₃, wherein R⁴ is selected from hydrogen, alkanyl, alkenyl, arylalkanyl, arylalkenyl, oxyalkanyl, oxyalkenyl, aminoalkanyl, aminoalkenyl, alkanyl ether and alkenyl ether.

The ligand having the general formula (VE), as defined above, is a pentadentate ligand or, if R¹═R², can be a hexadentate ligand. As mentioned above, by ‘pentadentate’ is meant that five hetero atoms can coordinate to the metal M ion in the metal-complex. Similarly, by ‘hexadentate’ is meant that six hetero atoms can in principle coordinate to the metal M ion. However, in this case it is believed that one of the arms will not be bound in the complex, so that the hexadentate ligand will be penta coordinating.

In the formula (VE), two hetero atoms are linked by the bridging group W and one coordinating hetero atom is contained in each of the three R¹ groups. Preferably, the coordinating hetero atoms are nitrogen atoms.

The ligand of formula (VE) comprises at least one optionally substituted heteroaryl group in each of the three R¹ groups. Preferably, the heteroaryl group is a pyridin-2-yl group, in particular a methyl- or ethyl-substituted pyridin-2-yl group. The heteroaryl group is linked to an N atom in formula (VE), preferably via an alkylene group, more preferably a methylene group. Most preferably, the heteroaryl group is a 3-methyl-pyridin-2-yl group linked to an N atom via methylene.

The group R² in formula (VE) is a substituted or unsubstituted alkyl, aryl or arylalkyl group, or a group R¹. However, preferably R² is different from each of the groups R¹ in the formula above. Preferably, R² is methyl, ethyl, benzyl, 2-hydroxyethyl or 2-methoxyethyl. More preferably, R² is methyl or ethyl.

The bridging group W may be a substituted or unsubstituted alkylene group selected from —CH₂CH₂—, —CH₂CH₂CH₂—, —CH₂CH₂CH₂CH₂—, —CH₂—C₆H₄—CH₂—, CH₂—C₆H₁₀—CH₂—, and —CH₂—C₁₀H₆—CH₂— (wherein —C₆H₄—, —C₆H₁₀—, —C₁₀H₆— can be ortho-, para-, or meta-C₆H₄—, —C₆H₁₀—, —C₁₀H₆—). Preferably, the bridging group W is an ethylene or 1,4-butylene group, more preferably an ethylene group.

Preferably, V represents substituted pyridin-2-yl, especially methyl-substituted or ethyl-substituted pyridin-2-yl, and most preferably V represents 3-methyl pyridin-2-yl.

Other suitable organic molecules (ligands) and complexes for use with the present invention are found, for example in: GB 9906474.3; GB 9907714.1; GB 98309168.7, GB 98309169.5; GB 9027415.0 and GB 9907713.3; DE 19755493; EP 999050; WO-A-9534628; EP-A-458379; EP 0909809; U.S. Pat. No. 4,728,455; WO-A-98139098; WO-A-98/39406, WO-A-97/48787, WO-A-00/29537; WO-A-00/52124, and WO-A-00/60045 the complexes and organic molecule (ligand) precursors of which are herein incorporated by reference.

One such suitable class of ligand comprises the ligands having the formula (VI):

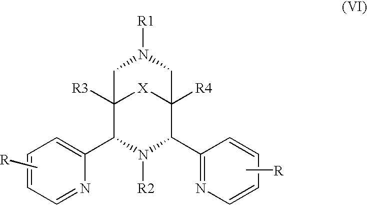

wherein each R is independently selected from: hydrogen, hydroxyl, —NH—CO—H, —NH—CO—C1-C4-alkyl, -NH2,-NH-C1-C4-alkyl, and C1-C4-alkyl;

R1 and R2 are independently selected from:

C1-C4-alkyl,

C6-C10-aryl, and,

a group containing a heteroatom capable of coordinating to a transition metal, preferably wherein at least one of R1 and R2 is the group containing the heteroatom;

R3 and R4 are independently selected from hydrogen, C1-C8 alkyl, C1-C8-alkyl-O-C1-C8-alkyl, C1-C8-alkyl-O-C6-C10-aryl, C6-C10-aryl, C1-C8-hydroxyalkyl, and —(CH2)ₙC(O)OR5

wherein R5 is C1-C4-alkyl, n is from 0 to 4, and mixtures thereof; and,

X is selected from C═O, —[C(R6)₂]_{y}— wherein Y is from 0 to 3 each R6 is independently selected from hydrogen, hydroxyl, C1-C4-alkoxy and C1-C4-alkyl.

It is preferred that the group containing the hetroatom is:

a heterocycloalkyl: selected from the group consisting of: pyrrolinyl; pyrrolidinyl; morpholinyl; piperidinyl; piperazinyl; hexamethylene imine; 1,4-piperazinyl; tetrahydrothiophenyl; tetrahydrofuranyl; tetrahydropyranyl; and oxazolidinyl, wherein the heterocycloalkyl may be connected to the ligand via any atom in the ring of the selected heterocycloalkyl,a —C1-C6-alkyl-heterocycloalkyl, wherein the heterocycloalkyl of the —C1-C6-heterocycloalkyl is selected from the group consisting of: piperidinyl; piperidine; 1,4-piperazine,tetrahydrothiophene; tetrahydrofuran; pyrrolidine; and tetrahydropyran, wherein the heterocycloalkyl may be connected to the —C1-C6-alkyl via any atom in the ring of the selected heterocycloalkyl,

a —C1-C6-alkyl-heteroaryl, wherein the heteroaryl of the —C1-C6-alkylheteroaryl is selected from the group consisting of: pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the —C1-C6-alkyl via any atom in the ring of the selected heteroaryl and the selected heteroaryl is optionally substituted by —C1-C4-alkyl,

a —C0-C6-alkyl-phenol or thiophenol,

a —C2-C4-alkyl-thiol, thioether or alcohol,

a —C2-C4-alkyl-amine, and

a —C2-C4-alkyl-carboxylate.

The counter ions Y in formula (A1) (as hereinbefore defined) balance the charge z on the complex formed by the ligand L, metal M and coordinating species X. Thus, if the charge z is positive, Y may be an anion such as RCOO⁻, BPh₄⁻, ClO₄⁻, BF₄⁻, PF₆⁻, RSO₃⁻, RSO₄⁻, SO₄²⁻, NO₃⁻, F⁻, Cl⁻, Br⁻, or I⁻, with R being hydrogen, optionally substituted alkyl or optionally substituted aryl. If z is negative, Y may be a common cation such as an alkali metal, alkaline earth metal or (alkyl)ammonium cation.

Suitable counter ions Y include those which give rise to the formation of storage-stable solids. Preferred counter ions for the preferred metal complexes are selected from R⁷COO⁻, ClO₄⁻, BF₄⁻, PF₆⁻, RSO₃⁻ (in particular CF₃SO₃⁻), RSO₄⁻, SO₄²⁻, NO₃⁻, F⁻, Cl⁻, Br⁻, and I⁻, wherein R represents hydrogen or optionally substituted phenyl, naphthyl or C₁-C₄ alkyl.

It will be appreciated that the complex (A1) can be formed by any appropriate means, including in situ formation whereby precursors of the complex are transformed into the active complex of general formula (A1) under conditions of storage or use. Preferably, the complex is formed as a well-defined complex or in a solvent mixture comprising a salt of the metal M and the ligand L or ligand L-generating species. Alternatively, the catalyst may be formed in situ from suitable precursors for the complex, for example in a solution or dispersion containing the precursor materials. In one such example, the active catalyst may be formed in situ in a mixture comprising a salt of the metal M and the ligand L, or a ligand L-generating species, in a suitable solvent. Thus, for example, if M is iron, an iron salt such as FeSO₄ can be mixed in solution with the ligand L, or a ligand L-generating species, to form the active complex. Thus, for example, the composition may formed from a mixture of the ligand L and a metal salt MXₙ in which preferably n=1-5, more preferably 1-3. In another such example, the ligand L, or a ligand L-generating species, can be mixed with metal M ions present in the substrate or wash liquor to form the active catalyst in situ. Suitable ligand L-generating species include metal-free compounds or metal coordination complexes that comprise the ligand L and can be substituted by metal M ions to form the active complex according the formula (A1).

Throughout the description and claims generic groups have been used, for example alkyl, alkoxy, aryl. Unless otherwise specified the following are preferred group restrictions that may be applied to generic groups found within compounds disclosed herein:

alkyl: C1-C6-alkyl,

alkenyl: C2-C6-alkenyl,

cycloalkyl: C3-C8-cycloalkyl,

alkoxy: C1-C6-alkoxy,

alkylene: selected from the group consisting of: methylene; 1,1-ethylene; 1,2-ethylene; 1,1-propylene; 1,2-propylene; 1,3-propylene; 2,2-propylene; butan-2-ol-1,4-diyl; propan-2-ol-1,3-diyl; and 1,4-butylene,

aryl: selected from homoaromatic compounds having a molecular weight under 300,

arylene: selected from the group consisting of: 1,2-benzene; 1,3-benzene; 1,4-benzene; 1,2-naphthalene; 1,3-naphthalene; 1,4-naphthalene; 2,3-naphthalene; phenol-2,3-diyl; phenol-2,4-diyl; phenol-2,5-diyl; and phenol-2,-6-diyl,

heteroaryl: selected from the group consisting of: pyridinyl; pyrimidinyl; pyrazinyl; triazolyl, pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl,

heteroarylene: selected from the group consisting of: pyridin-2,3-diyl; pyridin-2,4-diyl; pyridin-2,5-diyl; pyridin-2,6-diyl; pyridin-3,4-diyl; pyridin-3,5-diyl; quinolin-2,3-diyl; quinolin-2,4-diyl; quinolin-2,8-diyl; isoquinolin-1,3-diyl; isoquinolin-1,4-diyl; pyrazol-1,3-diyl; pyrazol-3,5-diyl; triazole-3,5-diyl; triazole-1,3-diyl; pyrazin-2,5-diyl; and imidazole-2,4-diyl, heterocycloalkyl: selected from the group consisting of: pyrrolinyl; pyrrolidinyl; morpholinyl; piperidinyl; piperazinyl; hexamethylene imine; and oxazolidinyl,

amine: the group —N(R)₂ wherein each R is independently selected from: hydrogen; C1-C6-alkyl; C1-C6-alkyl-C6H5; and phenyl, wherein when both R are C1-C6-alkyl both R together may form an —NC3 to an —NC5 heterocyclic ring with any remaining alkyl chain forming an alkyl substituent to the heterocyclic ring,

halogen: selected from the group consisting of: F; Cl; Br and I,

sulphonate: the group —S(O)₂OR, wherein R is selected from: hydrogen; C1-C6-alkyl; phenyl; C1-C6-alkyl-C6H5; Li; Na; K; Cs; Mg; and Ca,

sulphate: the group —OS(O)₂OR, wherein R is selected from: hydrogen; C1-C6-alkyl; phenyl; C1-C6-alkyl-C6H5; Li; Na; K; Cs; Mg; and Ca,

sulphone: the group —(O)₂R, wherein R is selected from: hydrogen; C1-C6-alkyl; phenyl; C1-C6-alkyl-C6H5 and amine (to give sulphonamide) selected from the group: —NR′2, wherein each R′ is independently selected from: hydrogen; C1-C6-alkyl; C1-C6-alkyl-C6H5; and phenyl, wherein when both R′ are C1-C6-alkyl both R′ together may form an —NC3 to an —NC5 heterocyclic ring with any remaining alkyl chain forming an alkyl substituent to the heterocyclic ring,

carboxylate derivative: the group —C(O)OR, wherein R is selected from: hydrogen, C1-C6-alkyl; phenyl; C1-C6-alkyl-C6H5, Li; Na; K; Cs; Mg; and Ca,

carbonyl derivative: the group —C(O)R, wherein R is selected from: hydrogen; C1-C6-alkyl; phenyl; C1-C6-alkyl-C6H5 and amine (to give amide) selected from the group: —NR′2, wherein each R′ is independently selected from: hydrogen; C1-C6-alkyl; C1-C6-alkyl-C6H5; and phenyl, wherein when both R′ are C1-C6-alkyl both R′ together may form

an —NC3 to an —NC5 heterocyclic ring with any remaining alkyl chain forming an alkyl substituent to the heterocyclic ring,

phosphonate: the group —P(O)(OR)₂, wherein each R is independently selected from: hydrogen; C1-C6-alkyl; phenyl; C1-C6-alkyl-C6H5; Li; Na; K; Cs; Mg; and Ca,

phosphate: the group —OP(O)(OR)₂, wherein each R is independently selected from: hydrogen; C1-C6-alkyl; phenyl; C1-C6-alkyl-C6H5; Li; Na; K; Cs; Mg; and Ca,

phosphine: the group —P(R)₂, wherein each R is independently selected from: hydrogen; C1-C6-alkyl; phenyl; and C1-C6-alkyl-C6H5,

phosphine oxide: the group —P(O)R₂, wherein R is independently selected from: hydrogen; C1-C6-alkyl; phenyl; and C1-C6-alkyl-C6H5; and amine (to give phosphonamidate) selected from the group: —NR′2, wherein each R′ is independently selected from: hydrogen; C1-C6-alkyl; C1-C6-alkyl-C6H5; and phenyl, wherein when both R′ are C1-C6-alkyl both R′ together may form an —NC3 to an —NC5 heterocyclic ring with any remaining alkyl chain forming an alkyl substituent to the heterocyclic ring.

Unless otherwise specified the following are more preferred group restrictions that may be applied to groups found within compounds disclosed herein:

alkyl: C1-C4-alkyl,

alkenyl: C3-C6-alkenyl,

cycloalkyl: C6-C8-cycloalkyl,

alkoxy: C1-C4-alkoxy,

alkylene: selected from the group consisting of: methylene; 1,2-ethylene; 1,3-propylene; butan-2-ol-1,4-diyl; and 1,4-butylene,

aryl: selected from group consisting of: phenyl; biphenyl, naphthalenyl; anthracenyl; and phenanthrenyl,

arylene: selected from the group consisting of: 1,2-benzene, 1,3-benzene, 1,4-benzene, 1,2-naphthalene, 1,4-naphthalene, 2,3-naphthalene and phenol-2,6-diyl,

heteroaryl: selected from the group consisting of: pyridinyl; pyrimidinyl; quinolinyl; pyrazolyl; triazolyl; isoquinolinyl; imidazolyl; and oxazolidinyl,

heteroarylene: selected from the group consisting of: pyridin-2,3-diyl; pyridin-2,4-diyl; pyridin-2,6-diyl; pyridin-3,5-diyl; quinolin-2,3-diyl; quinolin-2,4-diyl; isoquinolin-1,3-diyl; isoquinolin-1,4-diyl; pyrazol-3,5-diyl; and imidazole-2,4-diyl,

heterocycloalkyl: selected from the group consisting of: pyrrolidinyl; morpholinyl; piperidinyl: and piperazinyl,

amine: the group —N(R)₂, wherein each R is independently selected from: hydrogen; C1-C6-alkyl; and benzyl,

halogen: selected from the group consisting of: F and Cl,

sulphonate: the group —S(O)₂OR, wherein R is selected from: hydrogen; C1-C6-alkyl; Na; K; Mg: and Ca,

sulphate: the group —OS(O)₂OR, wherein R is selected from: hydrogen; C1-C6-alkyl; Na; K; Mg: and Ca,

sulphone: the group —S(O)₂R, wherein R is selected from: hydrogen; C1-C6-alkyl; benzyl and amine selected from the group: —NR′2, wherein each R′ is independently selected from: hydrogen; C1-C6-alkyl; and benzyl,

carboxylate derivative: the group —C(O)OR, wherein R is selected from hydrogen; Na; K; Mg: Ca; C1-C6-alkyl; and benzyl,

carbonyl derivative: the group: —C(O)R, wherein R is selected from: hydrogen; C1-C6-alkyl; benzyl and amine selected from the group: —NR′2, wherein each R′ is independently selected from: hydrogen; C1-C6-alkyl; and benzyl,

phosphonate: the group —P(O)(OR)₂, wherein each R is independently selected from: hydrogen; C1-C6-alkyl, benzyl; Na; K; Mg; and Ca,

phosphate: the group —OP(O)(OR)₂, wherein each R is independently selected from: hydrogen; C1-C6-alkyl; benzyl; Na; K; Mg; and Ca,

phosphine: the group —P(R)₂, wherein each R is independently selected from: hydrogen; C1-C6-alkyl; and benzyl,

phosphine oxide: the group —P(O)R₂, wherein R is independently selected from: hydrogen; C1-C6-alkyl; benzyl and amine selected from the group: —NR′2, wherein each R′ is independently selected from: hydrogen; C1-C6-alkyl; and benzyl.

Other compounds or ligands forming complexes with transition metals, and which are capable of catalysing bleaching by atmospheric oxygen, are suitable as organic substances in the liquid bleaching compositions of the present invention. These include the classes of complexes of a transition metal coordinated to a macropolycyclic ligand disclosed in WO-A-98/39098 and WO-A-98/39406.

The substantially non-aqueous liquid cleaning composition may be used for laundry cleaning, hard surface cleaning (including cleaning of lavatories, kitchen work surfaces, floors, mechanical ware washing etc.). As is generally known in the art, bleaching compositions are also employed in waste-water treatment, pulp bleaching during the manufacture of paper, leather manufacture, dye transfer inhibition, food processing, starch bleaching, sterilisation, whitening in oral hygiene preparations and/or contact lens disinfection.

In the context of the present invention bleaching should be understood as relating generally to the decolourisation of stains or of other materials attached to or associated with a substrate. However, it is envisaged that the present invention can be applied where a requirement is the removal and/or neutralisation by an oxidative bleaching reaction of malodours or other undesirable components attached to or otherwise associated with a substrate. Furthermore, in the context of the present invention bleaching is to be understood as being restricted to any bleaching mechanism or process that does not require the presence of light or activation by light. Thus, photobleaching compositions and processes relying on the use of photobleach catalysts or photobleach activators and the presence of light are excluded from the present invention.

In typical washing compositions the level of the organic substance is such that the in-use level is from 0.05 μM to 50 mM, with preferred in-use levels for domestic laundry operations falling in the range 1 to 100 μM. Higher levels may be desired and applied in industrial bleaching processes, such as textile and paper pulp bleaching.

As already mentioned, the amount of the substantially non-aqueous liquid cleaning composition is each unit dose envelope may for example be from 10 ml to 100 ml, e.g. from 12.5 ml to 75 ml, preferably from 15 ml to 60 ml, more preferably from 20 ml to 55 ml. For unit dose products of these fill-volumes, the substantially non-aqueous liquid detergent composition may for example contain from 0.001 g to 0.5 g, preferably from 0.002 g to 0.3 g, more preferably from 0.0025 g to 0.25 g of the organic substance.

Therefore, the amount of the organic substance will typically be from 0.005% to 1%, preferably from 0.0075% to 0.5%, more preferably from 0.01% to 0.1% by weight of the total substantially non-aqueous liquid detergent composition.

When the organic substance is provided in the form of a complex with a transit metal ion, either preformed or formed in situ in the composition, the aforementioned weights and percentages include the metal ion.

### Other Components

The substantially non-aqueous liquid cleaning composition may further comprise one or more ingredients selected from non-ionic or cationic surfactants, builders, polymers, fluorescers, enzymes, silicone foam control agents, perfumes, dyes, bleaches and preservatives.

Some of these materials will be solids which are insoluble in the substantially non-aqueous liquid medium. In that case, they will be dispersed in the substantially non-aqueous liquid medium and may be deflocculated by means of one or more acidic components such as selected from inorganic acids anionic surfactant acid precursors and Lewis acids, as disclosed in EP-A-266 199, as mentioned above.

### Uses

The present invention is not limited to those circumstances in which a washing machine is employed, but can be applied where washing is performed in some alternative vessel. In these circumstances it is envisaged that the unit dose product can be placed in a bowl, bucket or other vessel which is being employed, or from any implement which is being employed, such as a brush, bat or dolly, or from any suitable applicator.

The invention will now be further illustrated by way of the following non-limiting examples:

### EXAMPLES

### Example 1

This example describes a synthesis of the catalyst as employed in Example 2:

### (i) Preparation of MeN4Py ligand (A)

N,N-bis(pyridin-2-yl-methyl)-1,1-bis(pyridin-2-yl)-1-aminoethane, MeN4Py, was prepared according to the procedure found in EP 0 909 809 A.

### (ii) Synthesis of the Complex FeMeN4PyCl₂ (B)

MeN4Py ligand (33.7 g; 88.5 mmoles) was dissolved in 500 ml dry methanol. Small portions of FeCl₂.4H₂O (0.95 eq; 16.7 g; 84.0 mmoles) were added, yielding a clear red solution. After addition, the solution was stirred for 30 minutes at room temperature, after which the methanol was removed (rotary-evaporator). The dry solid was ground and 150 ml of ethylacetate was added and the mixture was stirred until a fine red powder was obtained. This powder was washed twice with ethyl acetate, dried in the air and further dried under vacuum (40° C.). EI. Anal. Calc. for [Fe(MeN4py)Cl]Cl.2H₂O: C 53.03; H 5.16; N 12.89; Cl 13.07; Fe 10.01%. Found C 52.29/52.03; H 5.05/5.03; N 12.55/12.61; Cl: 12.73/12.69; Fe: 10.06/10.01%.

### Incorporation of Metal Complexes into Unit Dose Products

| Ingredient | Wt % |
|---|---|
| Nonionic surfactant | 26.6 |
| Monopropylene glycol | 5.5 |
| Complex (B) | See below |
| Pigment premix | 0.017 |
| Glycerol | 21.36 |
| Monoethanolamine | 7.56 |
| Oleic fatty acid | 13.10 |
| Linear alkyl benzene sulfonate | 20.1 |
| Perfume | 1.6 |
| Protease Enzyme | 1.0 |
| Water | balance |

25 ml of the above formation added was filled into a polyvinyl alcohol film capsule formed by the horizontal form-fill technique. The film was of a kind incorporating a common having carboxylate functionality.

### Example 1

In a composition for demonstrable bleach activity in a single wash, the amount of complex (B) was 0.15% in the above formulation.

### Example 2

In a composition showing bleach activity over repeat washes, the amount of complex (B) was 0.01 wt % in the above formulation.

1. A unit dose cleaning product comprising a capsule formed of a material capable of dissolving, disintegrating or dispersing in a wash liquor, the capsule being filled with a substantially non-aqueous liquid cleaning composition in an amount sufficient to clean a single wash load, said composition including an organic substance with forms of a complex with a transition metal, the complex being capable of catalysing bleaching of a substrate by atmospheric oxygen.

2. The unit dose product of claim 1, wherein the organic substance comprises a pentadentate ligand of the general formula (B): 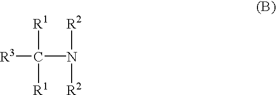
wherein
each R¹, R² independently represents —R⁴—R⁵,
R³ represents hydrogen, optionally substituted alkyl, aryl or arylalkyl, or —R⁴—R⁵,
each R⁴ independently represents a single bond or optionally substituted alkylene, alkenylene, oxyalkylene, aminoalkylene, alkylene ether, carboxylic ester or carboxylic amide, and
each R⁵ independently represents an optionally N-substituted aminoalkyl group or an optionally substituted heteroaryl group selected from pyridinyl, pyrazinyl, pyrazolyl, pyrrolyl, imidazolyl, benzimidazolyl, pyrimidinyl, triazolyl and thiazolyl.

3. The unit dose product of claim 2, wherein the ligand is N,N-bis(pyridin-2-yl-methyl)-1,1-bis(pyridin-2-yl)-1-aminoethane.

4. The unit dose product of claim 1, wherein the substantially non-aqueous liquid cleaning composition comprises from 0.005% to 1%, preferably from 0.0075% to 0.5%, more preferably from 0.01% to 0.1% by weight of the composition of total of the organic substance.

5. The unit dose product of claim 1, wherein the amount of the substantially non-aqueous liquid cleaning composition within the capsule is from 10 ml to 100 ml, preferably from 12.5 ml to 75 ml, more preferably from 15 ml to 60 ml, especially from 20 ml to 55 ml.

6. The unit dose product of claim 1, wherein substantially non-aqueous liquid cleaning composition within the capsule comprises from 0.001 g to 0.5 g, preferably from 0.002 g to 0.3 g, more preferably from 0.0025 g to 0.25 g by weight of total of the organic substance.

7. The unit dose product of claim 1, wherein the substantially non-aqueous liquid cleaning composition further comprises a surfactant.

8. The unit dose product of claim 1, wherein the substantially non-aqueous liquid cleaning composition further comprises a builder.

9. The unit dose product of claim 1, wherein the organic substance comprises a preformed complex of a ligand and a transition metal.

10. The unit dose product of claim 1, wherein the organic substance comprises a free ligand for complexing with a transition metal present in the water and/or present in the substrate.

11. The unit dose product of claim 1, wherein the organic substance comprises a composition of a free ligand or a transition metal-substitutable metal-ligand complex, and a source of transition metal.

12. A method of cleaning a substrate comprising bringing into contact, a wash liquor in which it immersed, the substrate and a unit dose cleaning product comprising a capsule formed of a material capable of dissolving, disintegrating or dispersing in a wash liquor, the capsule being filled with a substantially non-aqueous liquid cleaning composition in an amount sufficient to clean a single wash load, said composition including an organic substance with forms of a complex with a transition metal, the complex being capable of catalysing bleaching of a substrate by atmospheric oxygen.
